(19) United States
(12) Patent Application Publication
(10) Pub. No.: US 2026/0244717 A1
(43) Pub. Date: Aug. 20, 2026

(54) Systems and Methods for Modifying and Tracking Digital Media Using Substantially Imperceptible Identifiers and Blockchain-Based Verification

(71) Applicant: CEEK VR INC., Miami Beach, FL (US)

(72) Inventor: Mary Spio, Miami Beach, FL (US)

(21) Appl. No.: 19/214,993

(22) Filed: May 21, 2025

Related U.S. Application Data
(60) Provisional application No. 63/759,135, filed on Feb. 15, 2025.

(51) Int. Cl. G06F 21/16; H04L 9/00; H04L 9/32

(52) U.S. Cl. CPC G06F 21/16; H04L 9/3236; H04L 9/3247; H04L 9/50; H04L 2209/608

(57) ABSTRACT

A method for modifying and tracking digital media using substantially imperceptible identifiers is disclosed. A content asset is received over a communications network and modified using at least one processor by applying a substantially imperceptible variation to generate a modified content asset. A unique digital signature is generated based on features of the modified content, including spatial, temporal, spectral, or typographic characteristics, and the digital signature is stored in a blockchain ledger for immutable verification. The system may scan digital platforms for potential unauthorized copies, extract embedded variations, regenerate the digital signature, and verify it against the blockchain record. Variations may include pixel-level adjustments, audio signal alterations in inaudible frequency ranges, zero-width character insertions in text, or frame timing shifts in video. The system enables persistent, content-level traceability and supports automated enforcement actions, transforming media assets into verifiable, self-identifying entities suitable for rights management and anti-piracy enforcement.

### REFERENCE TO RELATED APPLICATIONS

This application is a non-provisional application which claims the benefit of the filing date of U.S. Provisional Application Serial No. 63/759,135 titled “SYSTEMS AND METHODS FOR AI-POWERED DIGITAL CONTENT PROTECTION AND AI-GENERATED VIDEO PRODUCTION” and filed February 15, 2025 and the subject matter of which is incorporated herein by reference.

### CROSS-REFERENCES

Not applicable.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISK

Not applicable.

### TECHNICAL FIELD

The present disclosure relates to the field of digital media processing and content tracking, and more specifically to the field of modifying digital media using substantially imperceptible variations and for tracking such media through content fingerprinting and blockchain-based verification.

### BACKGROUND OF THE INVENTION

The exponential growth in digital content creation and distribution has introduced major challenges in managing content ownership, tracking provenance, and preventing unauthorized use or redistribution. As media is increasingly shared across online platforms, social media, content-sharing networks, and streaming services, the ability of rights holders to enforce copyright and usage restrictions has become significantly impaired.

Traditional digital rights management (DRM) and watermarking systems rely on visible markers or basic metadata that can be easily stripped, altered, or rendered ineffective by common processing techniques such as cropping, re-encoding, filtering, or format conversion. While some invisible watermarking methods exist, they often compromise the quality of the media or are susceptible to signal degradation and loss during transmission or compression.

Furthermore, these conventional systems often rely on centralized databases or trusted intermediaries to store and verify content ownership and history. This introduces vulnerabilities related to data tampering, single points of failure, lack of interoperability, and limited transparency. Centralized systems also do not scale efficiently when monitoring content across diverse platforms in real-time.

In the case of video and image content, minor edits, such as resolution scaling, color filtering, or frame cropping, can render existing fingerprinting methods ineffective. For audio content, watermarking in perceptible frequency ranges can degrade user experience, while inaudible watermarking often lacks robustness against recompression or mixing. For textual content, simple copy-paste operations or formatting changes can eliminate identifying features, making enforcement extremely difficult.

As a result, there exists a need for improvements over the prior art and more particularly for a way to reliably identify and track digital content in a manner that is resilient to modification, imperceptible to users, and independent of centralized control.

### BRIEF SUMMARY OF THE INVENTION

A system and methods for modifying and tracking digital media using imperceptible identifiers is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a method for modifying and tracking digital media using imperceptible identifiers is disclosed. The system comprises receiving, over a communications network, a content asset from a content source. The method further comprises modifying, with at least one processor, the content asset by applying a substantially imperceptible variation to the content asset to generate a modified content asset. The method includes generating, with the processor, a unique digital signature for the modified content asset and storing, with the processor, the unique digital signature in a blockchain ledger. The content asset comprises a visual media, and the substantially imperceptible variation comprises at least one of applying a pixel-level adjustment, wherein at least one of pixel brightness, pixel color saturation, pixel contrast, and pixel arrangement is modified and applied to the content asset, modifying a portion of the content asset at a low amplitude to maintain a high signal-to-noise ratio, and applying a texture variation, comprising generating at least one of a noise pattern and a background detail and applying it into the content asset. The substantially imperceptible variation is applied based on a deterministic algorithm that generates a plurality of values, the plurality of values being used to determine at least one of a location, a type, an intensity of the variation within the content asset.

Generating the unique digital signature comprises performing content fingerprinting on the modified content asset, the content fingerprinting comprising analyzing, with the processor, the modified content asset to extract at least one of a spatial feature, a color distribution, an edge pattern, and an object structure, generating, with the processor, a perceptual hash based on the extracted features, applying a frequency-domain transformation, comprising at least one of a Discrete Cosine Transform, a wavelet transform, and a Fourier Transform, to generate a compression-resistant fingerprint, and generating, with the processor, a cryptographic hash based on at least one of the perceptual hash and the compression-resistant fingerprint.

In some embodiments, the visual media is a motion picture, wherein the substantially imperceptible variation comprises a frame timing adjustment. The content fingerprinting further comprises analyzing, with the processor, a temporal change between consecutive frames of the modified content asset to identify at least one of an object trajectory and a scene transition and generating a motion fingerprint based on at least one of a motion vector, a frame-to-frame spatial relationship, and a temporal feature persistence, wherein the motion fingerprint is used in generating the unique digital signature.

In some embodiments, the motion picture comprises an auditory media, wherein the substantially imperceptible variation comprises at least one of modifying a signal component within a substantially inaudible frequency range of an audio signal of the content asset and embedding a watermark in a spectral pattern within a spectrogram of the audio signal. The content asset comprises a textual component, and the substantially imperceptible variation comprises at least one of a zero-width character inserted within the text, an adjustment of a typographic format, including at least one of a line height, a kerning, a character spacing, and a word spacing, and a semantically equivalent word and symbol substituted within the text.

The method further comprises scanning digital content on a connected database, with the processor, for unauthorized copies of the modified content asset, the scanning comprising retrieving a digital content from at least one of an online platform, a content-sharing network, and a streaming service, extracting a content feature from the digital content, wherein the content feature comprises at least one of a spatial feature, a motion vector, a color distribution, and an object structure, generating a similarity probability indicating a likelihood that the retrieved digital content corresponds to the modified content asset, determining whether the similarity probability exceeds a predetermined confidence threshold, and in response to determining that the similarity probability exceeds the confidence threshold, extracting an embedded digital signature from the digital content and tracing metadata associated with the embedded digital signature to determine a provenance of the modified content asset and determining an unauthorized distribution of the modified content asset.

The method further comprises initiating an enforcement action with a third party, with the processor, over the communications network, upon determining the unauthorized distribution of the modified content asset, wherein the enforcement action comprises at least one of submitting an automated copyright takedown request, issuing a legal notice to an unauthorized distributor, and triggering a smart contract-based royalty payment. The method further comprises generating an anti-piracy alert and sending a message to a remote computing device, with the processor, in response to detecting the unauthorized distribution of the modified content asset.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1 is a diagram of an operating environment that supports a system for modifying and tracking digital media using imperceptible identifiers, according to an example embodiment;

FIG. 2 is a schematic illustrating communication between the entities in FIG. 1 in relation to the system for modifying and tracking digital media using imperceptible identifiers, according to an example embodiment;

FIG. 3A is a block diagram of the blockchain network pertaining to generating and storing a unique digital signature for the modified content asset, according to an example embodiment;

FIG. 3B is a block diagram of the blockchain network pertaining to generating and storing a unique digital signature for the modified content asset, according to an example embodiment;

FIG. 4 is a flowchart diagram illustrating the steps for a method for modifying and tracking digital media using imperceptible identifiers, according to an example embodiment;

FIG. 5 is a flowchart diagram illustrating the steps for a method for the substantially imperceptible variation of visual media, according to an example embodiment;

FIG. 6 is a flowchart diagram illustrating the steps for a method for performing content fingerprinting on the modified content asset, according to an example embodiment;

FIG. 7 is a flowchart diagram illustrating the steps for a method for the substantially imperceptible variation of auditory media, according to an example embodiment;

FIG. 8 is a flowchart diagram illustrating the steps for a method for the substantially imperceptible variation of a content asset including a textual component, according to an example embodiment;

FIG. 9 is a flowchart diagram illustrating the steps for a method for scanning digital content on a connected database for unauthorized copies of the modified content asset, according to an example embodiment;

FIG. 10 is a flowchart diagram illustrating the steps for a method for initiating an enforcement action with a third party, according to an example embodiment;

FIG. 11 illustrates the process of the substantially imperceptible variation of auditory media, according to an example embodiment;

FIG. 12 illustrates the process of the substantially imperceptible variation of visual media, according to an example embodiment;

FIG. 13 illustrates the process of the substantially imperceptible variation of the textual component, according to an example embodiment;

FIG. 14 illustrates a graphical user interface for an anti-piracy alert, according to an example embodiment;

FIG. 15 is a block diagram of a system including an example computing device and other computing devices, according to an example embodiment.

Like reference numerals refer to like parts throughout the various views of the drawings.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system for content protection by combining imperceptible, content-sensitive modifications with deterministic control, resilient fingerprinting, decentralized verification, and automated enforcement. These capabilities collectively enhance the system's ability to monitor, verify, and protect digital media assets across diverse and dynamic distribution environments. Traditional digital watermarking and content tracking systems often rely on visible overlays, simple metadata tagging, or fragile identifiers that are easily removed, degraded, or rendered ineffective through routine content transformations such as compression, re-encoding, cropping, or format shifting. These prior systems typically lack resilience, scalability, and automation, and they frequently require human intervention to validate content origin or initiate enforcement actions. As a result, the existing methods and system provide limited deterrence to piracy and are insufficient for modern, decentralized digital content ecosystems.

The present embodiments improve upon such prior systems by embedding substantially imperceptible variations directly into the underlying structure of digital content assets in a manner that is both content-aware and algorithmically controlled. In particular, the application of imperceptible variation based on a deterministic algorithm that generates pseudo-random values enables content modifications that are both unpredictable to third parties and precisely reproducible by authorized systems. This ensures that each content asset can carry a unique, persistent identity that remains intact and detectable even after being subjected to various forms of distortion or redistribution.

Unlike conventional watermarking techniques that often degrade media quality or require manual placement, the described system applies content variations in perceptually optimized locations, including low-sensitivity image regions, spectrally masked audio intervals, or non-disruptive typographic positions. These modifications are designed to remain undetectable by human senses while being resilient to signal manipulation, thereby offering a higher level of robustness and discretion than legacy approaches.

Additionally, the integration of fingerprinting techniques, including perceptual hashing, frequency-domain transformation, and motion vector analysis, enables comprehensive identification of content features that survive format changes. These features are synthesized into a digital signature that can be recorded immutably in a blockchain ledger, providing decentralized, tamper-evident traceability of content provenance and distribution history. This contrasts with conventional hash-based or metadata-based identifiers, which are easily broken by minor content alterations or intentionally removed during unauthorized sharing.

Furthermore, the system automates detection and enforcement workflows. It continuously scans digital platforms for infringing content, computes similarity probabilities using robust matching algorithms, and triggers automated responses such as copyright takedown requests, legal notices, or smart contract executions. This end-to-end automation of content protection reduces the reliance on human review and legal processing, offering a scalable and responsive alternative to the time-consuming and fragmented procedures typical of prior art systems.

From a technological standpoint, this approach represents a functional improvement in media processing systems by enabling content to carry self-contained identity data. The content is no longer just a file or stream to be monitored externally—it is programmatically converted into a traceable medium, intrinsically tied to a unique digital signature derived from its own imperceptibly modified structure. This signature is further registered on a blockchain ledger, providing immutable, decentralized, and time-stamped verification of origin and ownership.

By integrating fingerprinting, imperceptible variation, and blockchain-backed identity into a unified system, the technology enhances the security, integrity, and auditability of media assets without reliance on external or manual tracking tools. It also increases the robustness of rights enforcement mechanisms, enabling automated responses to unauthorized use, such as takedown requests, legal notifications, or smart contract activations. Additionally, by embedding tracking information at the content level, the system ensures persistence of attribution and traceability, even as the content is compressed, re-encoded, clipped, or redistributed across disparate platforms.

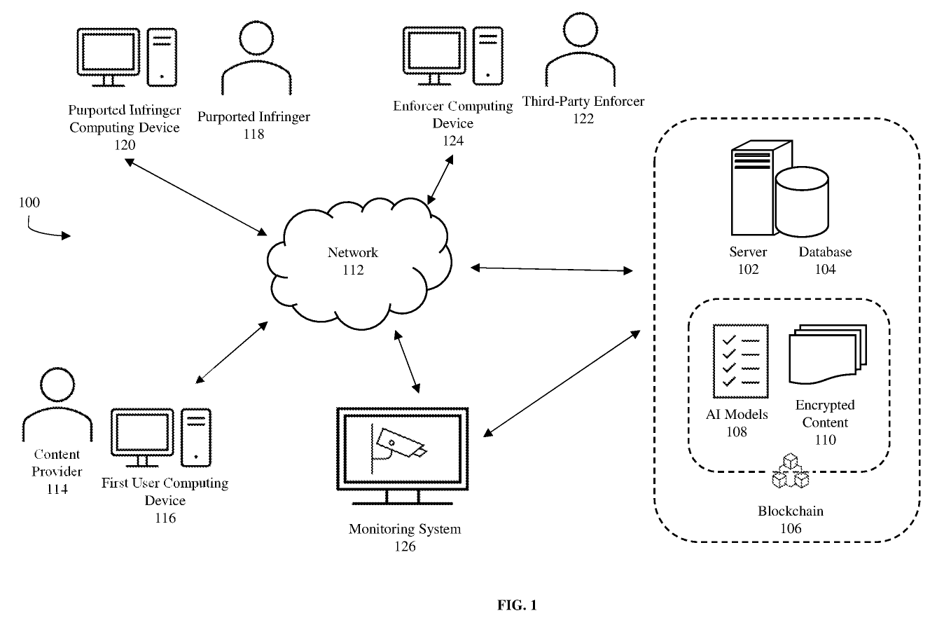

Referring now to the Figures, FIG. 1 illustrates an operating environment 100 that supports a system and method for modifying and tracking digital media using imperceptible identifiers, according to an example embodiment. In some embodiments, digital media may be audio-based media, including but not limited to music content that is distributed, streamed, or shared through platforms such as Spotify, YouTube, Apple Music, SoundCloud, and other digital audio services. This category of content encompasses both individual music tracks and audio embedded within multimedia formats such as music videos or promotional clips. The system provides an integrated framework for receiving digital content, generating unique content fingerprints, embedding AI-generated watermarks, registering content ownership on a blockchain ledger, monitoring online platforms for unauthorized distribution, and enforcing digital rights through automated smart contracts. The operating environment 100 comprises multiple interconnected components, including a content provider 114, a network 112, a server 102, a database 104, a blockchain ledger 106, a monitoring system 126, a purported infringer 118, an enforcer computing device 124, and a third-party enforcer 122. Each of these components plays a role in ensuring digital content remains protected and that unauthorized distribution is identified and addressed in an automated, scalable manner.

The content provider 114 represents an entity responsible for generating or distributing digital content. The content provider 114 interacts with the system via a first user computing device 116, which may be implemented as a personal computer, workstation, mobile device, or another network-connected device configured to upload digital media. The digital content input may include at least one of a video, an image, an audio file, a text-based document, or a live-streamed event. Once the digital content is received, it is transmitted over the network 112, which can be a circuit switched network, such as the Public Service Telephone Network (PSTN), or a packet switched network, such as the Internet or the World Wide Web, the global telephone network, a cellular network, a mobile communications network, or any combination of the above. In one embodiment, network 112 is a secure network wherein communications between endpoints are encrypted so as to ensure the security of the data being transmitted. The network facilitates communication between the content provider 114, the monitoring system 126, the server 102, and various enforcement entities.

The server 102 is responsible for processing the digital content to generate a unique content fingerprint and embed an AI-generated watermark. The AI models 108, executed on the server 102, analyze the digital content and extract key characteristics, such as spatial features, temporal characteristics, material properties, and motion vectors. The extracted features are then used to generate a unique digital signature, which serves as a cryptographic identifier for the content. The digital signature remains consistent even when the content undergoes minor modifications such as compression, cropping, or format changes. Additionally, the server 102 applies an AI-generated watermark, which may include pixel-level mutations, frame timing adjustments, spectrogram frequency shifts, or AI-modified texture variations. These watermarking techniques allow for robust content identification, ensuring that the content owner can verify authorship even if the file is altered or redistributed.

FIG. 1 further shows that server 102 includes a database or repository 104, which may be one or more of a relational databases comprising a Structured Query Language (SQL) database stored in a SQL server, a columnar database, a document database and a graph database. Computing devices 116, 120, and 124 and monitoring system 126 may also include their own database. The repository 104 serves data from a database, which is a repository for data used by server 102 and the mobile devices during the course of operation of the invention. Database 104 may be distributed over one or more nodes or locations that are connected via network 112.

The database 104 is coupled to the server 102 and is configured to store metadata associated with the protected content. The metadata includes the unique digital signature, timestamp of content submission, ownership details, and licensing terms. Additionally, the encrypted content 110 may be stored in the database, allowing for later retrieval and verification during enforcement actions. To ensure content integrity and verifiability, the system registers the unique digital signature on a blockchain ledger 106. The blockchain ledger serves as an immutable, decentralized record of content ownership, licensing terms, and transaction history. This ensures that any claims of ownership or unauthorized use can be cryptographically verified without reliance on a centralized authority.

FIG. 1 shows an embodiment wherein networked computing devices 116, 120, 124, and 126 may interact with server 102 and repository 104 over the network 112. Server 102 includes a software engine that delivers applications, data, program code and other information to networked computing devices 116, 124, and 126. The software engine of server 102 may perform other processes such as audio and/or video streaming or other standards for transferring multimedia data in a stream of packets that are interpreted and rendered by a software application as the packets arrive. It should be noted that although FIG. 1 shows only two networked mobile computing devices 116, 124, and 126, the system of the present invention supports any number of networked computing devices connected via network 112, having at least the computing devices 116, 120, 124, and 126.

Server 102 also includes program logic comprising computer source code, scripting language code or interpreted language code that is compiled to produce executable file or computer instructions that perform various functions of the present invention. In another embodiment, the program logic may be distributed among more than one of server 102, computing devices 116 and 126, or any combination of the above.

Note that although server 102 is shown as a single and independent entity, in one embodiment of the present invention, the functions of server 102 may be integrated with another entity, such as each of computing devices 116 and 126. Further, server 102 and its functionality, according to a preferred embodiment of the present invention, can be realized in a centralized fashion in one computer system or in a distributed fashion wherein different elements are spread across several interconnected computer systems.

The monitoring system 126 continuously scans online platforms, streaming services, digital marketplaces, and peer-to-peer networks for unauthorized distributions of the protected content. The system employs AI-powered content tracking algorithms to detect matching fingerprints and embedded watermarks within publicly available media files. By analyzing online content and comparing it against stored fingerprints, the monitoring system can identify potential copyright violations, even when infringers attempt to obscure the original content through transformations such as resizing, color modifications, transcoding, or format conversions.

If the monitoring system detects an unauthorized copy of the protected content, the system initiates an enforcement process. The purported infringer 118 represents an entity or individual suspected of distributing the protected content without authorization. The purported infringer computing device 120 may be a personal computer, mobile device, cloud storage service, web hosting server, or another computing system that is involved in the unauthorized distribution. Upon detecting a match, the monitoring system transmits an alert to the enforcer computing device 124, which is operated by an enforcement entity responsible for executing legal or contractual responses to infringement.

The enforcement process may involve multiple automated actions, including issuing a takedown request, sending a legal notification, or initiating a royalty payment request. A takedown request is typically sent to an online platform or hosting provider, instructing them to remove the infringing content under the Digital Millennium Copyright Act (DMCA) or similar regulatory frameworks. A legal notification may be issued directly to the purported infringer, informing them of the copyright violation and potential consequences. Alternatively, the system may initiate a royalty payment request, allowing the infringing entity to obtain a proper license for continued use of the content. The enforcement process may be executed through smart contracts on the blockchain ledger 106, ensuring automated and tamper-proof enforcement actions without requiring direct human intervention.

In some instances, a third-party enforcer 122 may be involved in the enforcement process. The third-party enforcer 122 may be a governmental agency, a copyright protection service, an intellectual property monitoring firm, or an independent rights management organization. The third-party enforcer 122 may have access to additional databases, regulatory frameworks, or legal tools that support content owners in protecting their intellectual property. The third-party enforcer 122 may collaborate with the monitoring system 126 and enforcer computing device 124 to escalate legal action, impose penalties, or facilitate arbitration in disputes over content ownership.

The interconnected components of the operating environment 100 form an end-to-end AI-driven content protection system that enables automated detection, verification, and enforcement of digital rights. By leveraging AI-powered fingerprinting, adaptive watermarking, blockchain-based content registration, and smart contract enforcement mechanisms, the system ensures real-time, scalable, and efficient digital rights management across a wide range of online platforms. The ability to detect unauthorized distributions, execute automated takedown actions, and maintain an immutable blockchain-based ownership record enhances the security and transparency of digital content protection.

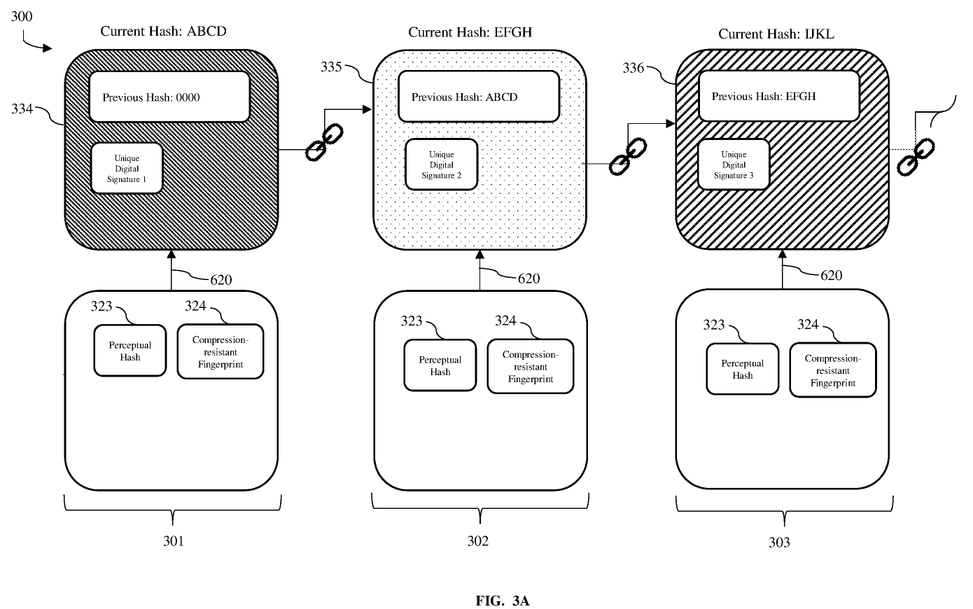

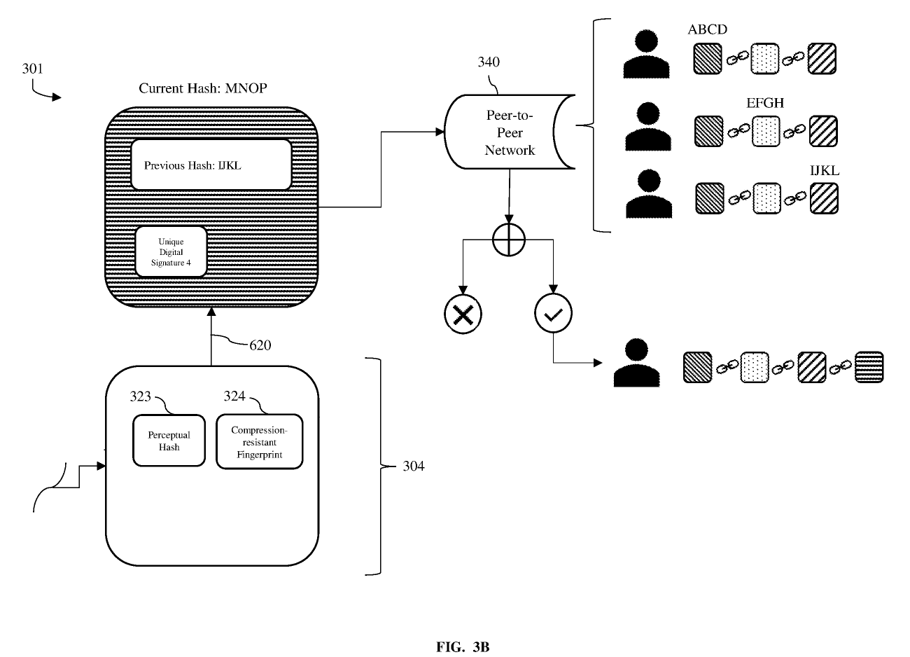

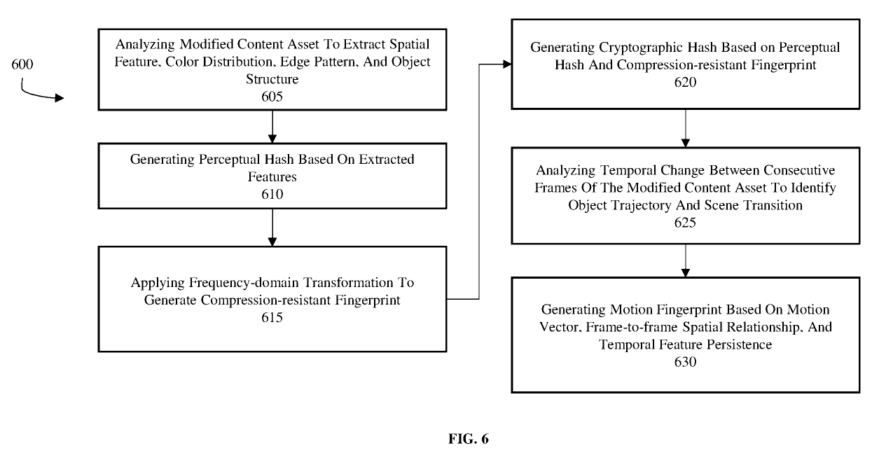

Referring now to FIG. 3A and 3B, a block diagram 300 of the blockchain network pertaining to generating and storing a unique digital signature for the modified content asset is shown, according to an example embodiment. After generating the perceptual hash and the compression-resistant fingerprint of modified content assets, an algorithm is applied to the data blocks 301, 302, and 303, including the corresponding perceptual hash and the compression-resistant fingerprint, before storing the data blocks on the ledger in blockchain format to generate 620 (further describe below with reference to FIG. 6) a cryptographic hash for the digital signatures. Each of the blocks 334, 335, and 336 illustrated in FIG. 3A illustrates a unique digital signature for each modified content asset. For example, generating the perceptual hash and the compression-resistant fingerprint of a modified content asset, an algorithm is applied to the perceptual hash and the compression-resistant fingerprint to produce a cryptographic hashed value for a unique digital signature that is stored on the ledger in blockchain format. Each of the blocks 334, 335, 336 includes the unique digital signature corresponding to a modified content asset. As illustrated in FIG. 3A, each of the blocks includes data 323 and 324 is related to a modified content asset. Referring to FIG. 3B, the most recent block 304 is illustrated being validated by the peer-to-peer network 340. Once the block is validated and stored on the blockchain, content asset associated with the block is tamper-resistant and verifiable.

By way of example, a digital image titled “Cityscape at Dusk” is received by a content protection system and is subsequently processed to apply a substantially imperceptible variation. In this example, the variation comprises minor pixel-level adjustments to brightness and color saturation across select regions of the image. These modifications are guided by a deterministic algorithm seeded with the content asset ID and a timestamp, ensuring that the variation is consistent and reproducible. Once the image has been modified, the system proceeds to generate a unique digital signature through a content fingerprinting process. The fingerprinting begins with feature extraction, during which the system analyzes the modified image to identify robust visual features. These features may include spatial attributes such as edges and corners, color distributions captured through histograms, edge patterns detected by gradient-based methods, and object structures derived using semantic segmentation via a trained neural network. Together, these features form a comprehensive representation of the image’s perceptual characteristics.

From these extracted features, the system generates a perceptual hash, which is a fixed-length binary string that represents the high-level visual structure of the image. This hash is resilient to common transformations such as resizing or compression. In parallel, the system applies a frequency-domain transformation, such as a Discrete Cosine Transform (DCT), to selected regions of the image to generate a compression-resistant fingerprint. This frequency-domain representation captures low-level signal patterns that persist even under lossy encoding.

The perceptual hash and the frequency-domain fingerprint are concatenated and processed using a cryptographic hash function, such as SHA-256, to produce a final digital signature. This signature is unique to the modified version of the content asset and is tamper-evident, meaning that even small changes to the input data will result in a completely different hash output. For example, the system may produce a 256-bit digital signature such as 1f3b6fa943e4c8d9a3ef72b7ff2070d6a6c5c2bb03ed5e9fe82bda5c927f3b1d.

This resulting digital signature, along with metadata including the asset ID, creation timestamp, media type, and version information, is then submitted as to a blockchain ledger. The blockchain entry provides an immutable and time-stamped record of the content asset’s fingerprint, allowing any future instance of the image, whether identical or altered, to be matched back to the original. This enables downstream authentication, distribution verification, and rights enforcement based on a cryptographically secured and tamper-resistant digital identifier.

In some embodiments, the system incorporates blockchain-based validators that operate as decentralized verification nodes to confirm the authenticity and provenance of a digital content asset by comparing extracted signatures against entries stored on a distributed ledger. These validators perform a critical role in automated integrity checking and decision-making, particularly in determining whether the similarity between a suspect content asset and a registered content signature exceeds a predefined confidence threshold sufficient to raise an alert or initiate an enforcement action. Each validator node is configured to receive or access a content fingerprint or an extracted digital signature from scanned or retrieved content. Upon receiving the extracted data, the validator performs a comparison against registered digital signatures stored immutably on the blockchain ledger. This may include comparing cryptographic hashes, perceptual fingerprints, motion vectors, spectral features, or other content-based identifiers that were previously written to the chain during the content modification phase.

The validators are programmed to compute a similarity probability score, which quantifies the degree of match between the extracted content features and the blockchain-stored signature. This similarity score may be generated using deterministic distance metrics (such as Hamming distance, cosine similarity, or cross-correlation) or probabilistic models tailored to the content modality (e.g., image, audio, video). If the similarity score exceeds a predefined confidence threshold, the validator classifies the content as potentially unauthorized or as a probable match to a protected asset. Once this threshold is met or exceeded, the validator transmits a validation result to the system, which may trigger additional downstream actions, such as raising an anti-piracy alert, extracting embedded metadata to determine content origin, or initiating an automated enforcement event, such as a copyright takedown request or smart contract execution. The use of a threshold ensures that alerts are only raised when there is a high probability of content identity, minimizing false positives while maintaining high sensitivity to unauthorized reuse or tampering.

Because the validators operate on a blockchain infrastructure, the validation process is decentralized, tamper-resistant, and transparent. Multiple validators can reach consensus on the authenticity or status of a content asset without relying on a single point of trust. This approach enhances the scalability, auditability, and trustworthiness of the content verification process, particularly in large-scale or cross-platform enforcement environments where digital content is distributed broadly and dynamically.

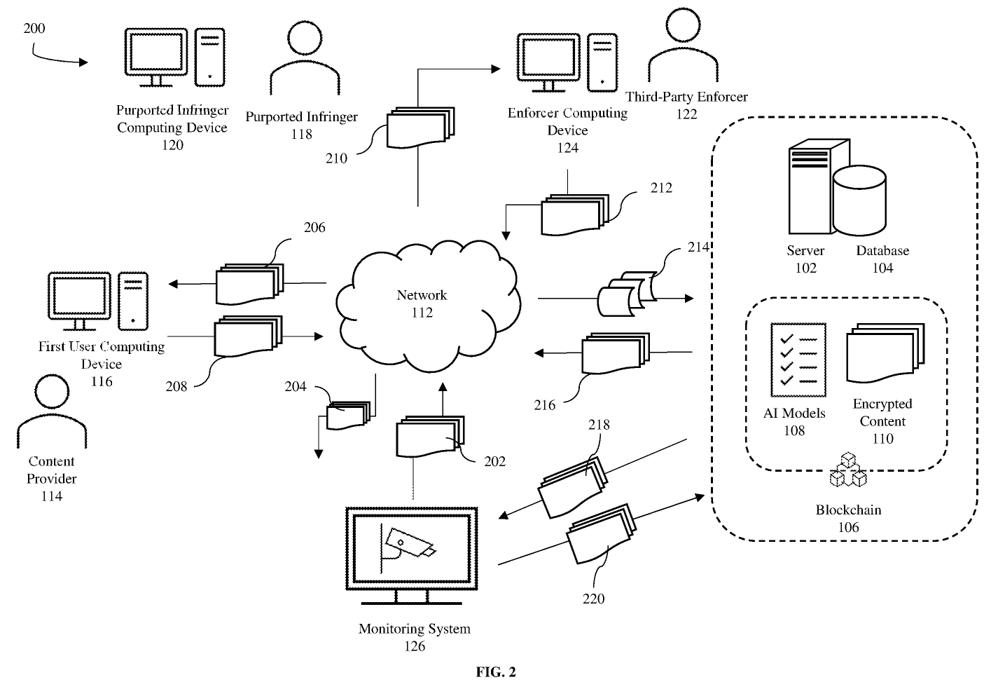

The process for modifying and tracking digital media using imperceptible identifiers will now be described with reference to FIGS. 2 and 4 through 10. FIGS. 2 and 4 through 10 depict, among other things, data flow and control flow in the process for modifying and tracking digital media using imperceptible identifiers, according to one embodiment. FIG. 2 is a schematic 200 illustrating communication between the entities in FIG. 1 in relation to modifying and tracking digital media using imperceptible identifiers, according to an example embodiment. It is understood that in FIG. 2, the data packets 202, 204, 206, 208, 210, 212, 214, 216, 218, and 220 are used to show the transmission of data and may be used at different stages of the process. It is understood by those skilled in the art that the steps of the methods described herein are not limited to the specific order presented. Unless explicitly stated otherwise, the method steps may be performed in different sequences, rearranged, or performed concurrently where appropriate without departing from the scope and spirit of the invention. The described order is merely one exemplary embodiment, and variations in the sequence of steps may be made based on the particular circumstances of the implementation, application, or design preferences. For example, certain steps may be combined, omitted, or repeated depending on the operational conditions or requirements of the system. Accordingly, the scope of the invention should not be construed as being limited to the specific order of steps outlined in the methods.

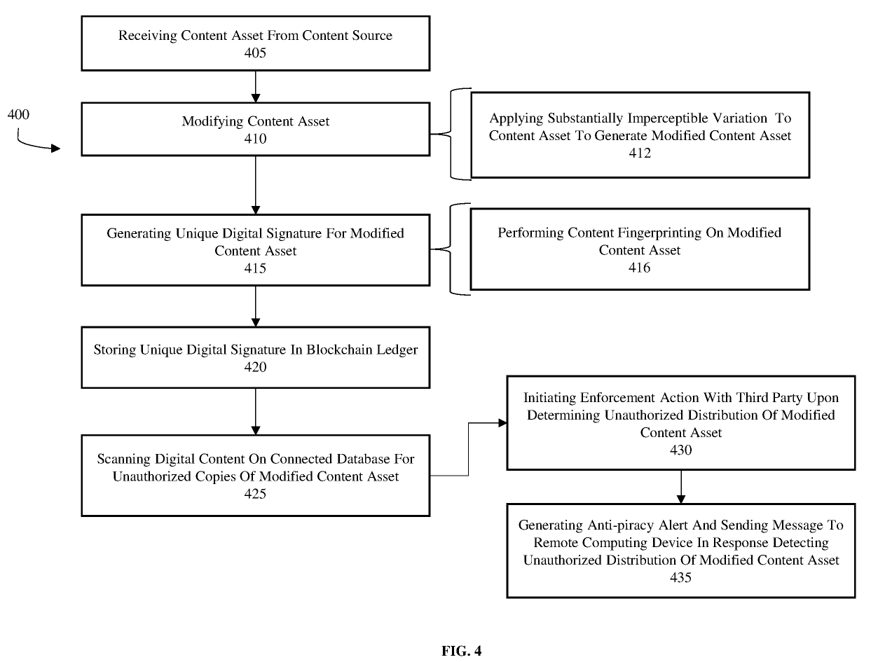

The content provider 114 may use the first user computing device 116 to communicate with the server 102, computing devices 120 and 124, and the monitoring system 126. The server 102 may provide graphical user interfaces to each of the first user computing device 116, computing devices 120 and 124, and the monitoring system 126. Each of the graphical user interfaces may be configured to allow the user to interact with the interface, and/or webpage, such that the interface(s) and display(s) may include a plurality of user interface elements such as input controls, navigation components, informational components, and containers. Such user interface elements may include for example, accordions, bento menu(s), breadcrumb(s), button(s), card(s), carousel(s), check box(es), comment(s), doner menu(s), dropdown(s), feed(s), form(s), hamburger menu(s), icon(s), input field(s), kebab menu(s), loader(s), meatball menu(s), modal(s), notification(s), pagination(s), picker(s), progress bar(s), radio button(s), search field(s), sidebar(s), slide control(s), stepper(s), tag(s), tab bar(s), tool tip(s), and toggle(s). Each of these user interface elements may be used in certain embodiments to enable each of the users to interact with the system, provide data to and from the server across the communications network and implement the methods as discussed in FIGS. 4 through 10. Other user interface elements configured to provide a display to the user to interact with the system in accordance with the methods described herein may be used and are within the spirit and scope of the disclosure. The user may interact with the graphical user interfaces using computer gestures to trigger certain elements on the graphical user interfaces. A computer gesture may include gestures such as a tap, via a touch sensitive interface display, a click, on or near one of the second user graphical indicators.

With reference to FIG. 4, a flowchart diagram illustrating the steps for a method 400 for modifying and tracking digital media using imperceptible identifiers is shown, according to an example embodiment. The method 400 may be executed by a system comprising one or more processors, memory, a network interface, and optionally a blockchain interface, all configured to perform the steps described below.

In step 405, the system receives, over a communications network, a content asset from a content source. The content source, as referenced herein, refers to any origin or originating entity from which a digital content asset is received for processing, modification, tracking, or verification. The content source may encompass a wide range of input channels, formats, and media generation mechanisms, and is not limited to a particular device, platform, or transmission method. Examples of content sources include live streaming feeds, such as video captured in real-time from cameras, drones, or surveillance systems; and social media platforms, where users upload or share content through services such as Instagram, YouTube, TikTok, Facebook, and others. The content source may also be a generative AI system, including tools that create synthetic images, videos, text, or audio using neural networks or large language models, such as deepfake generators, AI art tools, or text-to-speech engines. In other cases, the content source may involve a physical upload, where analog or offline media is digitized and introduced into the system via file upload, external drives, or scanned physical media. Additional content sources include cloud storage repositories, such as Google Drive, Dropbox, or enterprise servers where media assets are stored and accessed; enterprise content management systems, which organize and distribute digital assets across organizations; and content delivery networks (CDNs) that serve media files to distributed users but may also act as ingestion points. In some implementations, the content source may also be an API-based integration, such as an automated content feed from a third-party application, or a mobile device, from which content is uploaded directly via a native application. Regardless of the origin, the content source serves as the system’s initial point of contact for receiving and processing a content asset for subsequent imperceptible variation, fingerprinting, and digital signature generation.

The content source may be a content creator, a content management server, or a user device configured to upload or transmit digital media. The content asset may include any form of digital media, including but not limited to still images, video files, audio files, or text-based documents. The communications network may be a wired or wireless network, including but not limited to the Internet, an intranet, or a peer-to-peer network. The received content asset is temporarily stored in system memory for further processing.

In step 410, the system modifies the content asset using at least one processor. This step encompasses preprocessing the asset, parsing the media type, and applying internal transformation protocols. As part of this modification process, the system prepares the content for embedding an identifier while preserving the perceptual quality of the media. The modification may include digital reformatting, resolution scaling, or codec adjustments depending on the media type and intended distribution environment.

In step 412, modifying 410 the content asset includes applying a substantially imperceptible variation to the content asset to generate a modified content asset. The substantially imperceptible variation refers to at least one type of modification applied to a content asset that is not readily perceivable during ordinary use. This means that the variation is introduced in such a manner that it does not alter the way the content is experienced by a typical human user engaging with the media through standard devices, environments, or playback conditions. This imperceptible variation is engineered such that it remains undetectable to human perception while encoding identifiable data into the content. For visual media, this may involve pixel-level adjustments to brightness, contrast, or color channels that are uniformly distributed or confined to regions of low perceptual sensitivity. For audio media, the system may embed alterations in frequency ranges that fall outside the average human auditory range. In textual content, imperceptible changes may include the insertion of zero-width characters, adjustments to line height or spacing, or substitutions of semantically equivalent words that do not affect the meaning or readability. In one embodiment, the imperceptible variation is generated based on a deterministic algorithm, which ensures consistent application of modifications while introducing traceability.

The term “deterministic algorithm” refers to an algorithmic process that, when provided with a consistent input or seed value, produces a repeatable sequence of outputs. In certain embodiments, these outputs take the form of pseudo-random values, which are numerically randomized values that appear statistically unpredictable but are generated by a deterministic computational process, typically using a mathematical algorithm. Unlike true randomness, which is inherently unpredictable and derived from physical phenomena (such as radioactive decay or atmospheric noise), pseudo-random values are generated by pseudo-random number generators (PRNGs) that produce sequences of numbers based on an initial input known as a seed. The use of pseudo-random values provides spatial and parametric diversity in the application of the imperceptible variation, while the deterministic nature of the algorithm ensures that the same variation can later be regenerated or decoded for verification or tracking purposes. In the context of digital media processing, pseudo-random values may be used to control the location, type, or intensity of imperceptible variations applied to a content asset. For example, a system may use a PRNG to determine which pixels in an image should be modified, or which time intervals in an audio signal should be altered, thereby embedding identifiable data in a way that is statistically unstructured to an observer, yet precisely recoverable by the system.

In one embodiment, the deterministic algorithm may take as input a content identifier, timestamp, user-specific key, or cryptographic seed, and generate a series of pseudo-random values through a mathematical function such as a linear congruential generator or a hash-based pseudo-random number generator. These pseudo-random values are then mapped to specific coordinates or regions within the content asset to determine the location at which the variation is to be applied. For visual content, this may correspond to pixel positions, blocks, or zones within an image or video frame; for audio content, this may correspond to time intervals or frequency bands; and for textual content, it may correspond to character positions or word boundaries. The system is configured to intelligently identify areas within a digital content asset that are most likely to be perceptually tolerant to modification, and then applies pseudo-random variations within those areas to embed imperceptible identifiers. This approach ensures that modifications do not degrade the quality or usability of the content, while still embedding robust, traceable data.

To achieve this, the system first performs a content-aware analysis of the asset, whether image, audio, video, or text, to identify regions where human perception is least sensitive to subtle changes. In visual media, for example, the system may use saliency detection, edge maps, or texture analysis to distinguish between high-sensitivity areas (such as faces or foreground objects) and low-sensitivity areas (such as backgrounds, repetitive patterns, or low-contrast regions). In audio content, perceptual models such as the masking threshold are used to detect frequency bands or time intervals where low-amplitude signals are unlikely to be heard. For video, low-motion areas or background sequences may be selected, and for text, areas with typographic or structural redundancy may be prioritized.

Once the system has identified these perceptual tolerance zones, it uses a deterministic pseudo-random algorithm to select the exact coordinates or positions within those zones for modification. The use of pseudo-random values ensures that the variation appears statistically unstructured, making it extremely difficult for unauthorized users to detect or remove, but remains predictable and reproducible for authorized systems that possess the original seed or configuration parameters. The result is a process in which perceptual insignificance is maximized by combining targeted content analysis with randomized placement. The modifications are small enough to avoid perceptual detection and are applied in areas where even slight changes are unlikely to register visually or audibly. This technique allows the content to be transformed into a traceable entity without impacting its aesthetic, acoustic, or semantic integrity.

In addition to determining location, the pseudo-random values also govern the type of variation to be applied. For example, the algorithm may map certain values into one of several variation techniques, such as brightness modulation, texture overlay, zero-width character insertion, or frequency masking. This allows the variation scheme to dynamically adjust based on content characteristics while remaining unpredictable and difficult to reverse-engineer.

The intensity of the variation, i.e., the degree to which the content is modified, is also controlled by the pseudo-random values. The algorithm may apply lower or higher amplitude changes depending on the local tolerance of the content. For instance, a higher variation amplitude may be used in high-texture image regions where perceptual thresholds are higher, while lower amplitude variations are reserved for smoother areas to avoid detection. For audio content, the system may use perceptual models to apply greater modifications in spectrally masked regions while reducing intensity in sensitive frequency zones.

The use of pseudo-randomized yet deterministic control enables a sophisticated embedding scheme that distributes imperceptible modifications across the content asset in a manner that appears statistically natural and unstructured. However, because the same sequence of pseudo-random values can be regenerated from the original seed, the variation pattern is fully traceable and verifiable, allowing for downstream detection, fingerprinting, or authentication. This approach significantly enhances the robustness, scalability, and security of the system compared to manually designed or static embedding patterns.

In step 415, the system generates a unique digital signature for the modified content asset using the processor. This digital signature is a machine-verifiable identifier derived from intrinsic features of the modified asset. In one embodiment, the system performs content fingerprinting to extract structural or statistical characteristics of the media. For visual media, the system may extract spatial features, edge contours, color distributions, or object boundaries. For audio, it may extract temporal amplitude patterns, spectral energy densities, or formant trajectories. These extracted features may be processed using a frequency-domain transformation, such as a Discrete Cosine Transform (DCT), Fourier Transform, or wavelet transform, to produce a robust, compression-resistant representation. A perceptual hash is generated from this representation, followed by application of a cryptographic hash function to yield the unique digital signature.

In step 416, the system performs content fingerprinting on the modified content asset as part of the digital signature generation. This step comprises detailed analysis of the modified media content to detect and encode invariant features that survive typical media transformations such as compression, resizing, cropping, or re-encoding. In one embodiment, the system applies feature detection algorithms (e.g., SIFT, SURF, or HOG for visual content; MFCC or chroma-based extraction for audio content) to generate a high-dimensional feature vector that captures the essence of the content’s perceptual identity.

In step 420, the system stores the unique digital signature in a blockchain ledger using the processor. The blockchain ledger provides an immutable and decentralized record of the signature, ensuring that any subsequent modifications to the media or tampering attempts can be detected by comparing the content’s current signature against the originally stored version. The system may timestamp the digital signature and associate it with metadata such as content creator identity, distribution rights, and originating IP address. In some embodiments, the blockchain may support smart contracts, allowing for automated enforcement actions based on verifiable usage data.

In step 425, the system scans digital content on a connected database for unauthorized copies of the modified content asset. The connected database may comprise public online platforms, content-sharing networks, or internal archives of hosted content. The system retrieves candidate digital media and performs feature extraction on each item, applying the same fingerprinting algorithms used during the digital signature generation process. The system then compares the extracted features to the original fingerprint stored on the blockchain, calculating a similarity probability that indicates the likelihood that a given item corresponds to the modified content asset. If the similarity exceeds a predetermined threshold, the system identifies the asset as a potential unauthorized copy.

In step 430, upon determining that an unauthorized distribution of the modified content asset has occurred, the system initiates an enforcement action with a third party over the communications network. This enforcement action may include transmitting a digital rights violation report to a platform administrator, submitting an automated DMCA or equivalent copyright takedown request, or activating a smart contract to trigger financial penalties or royalty redistribution. The system may also maintain a log of enforcement actions for audit purposes.

In step 435, in response to detecting the unauthorized distribution of the modified content asset, the system generates an anti-piracy alert and sends a message to a remote computing device. The alert may be transmitted via email, SMS, or push notification, and may include details such as the location of the unauthorized copy, the matching confidence score, the embedded digital signature, and suggested remedial actions. The remote computing device may be associated with a content rights holder, a legal department, or a network monitoring authority.

The method 400 illustrated in FIG. 4 may be implemented as a set of instructions stored in non-transitory computer-readable media, executed by one or more processors operating on a server, cloud platform, or distributed edge devices. In some embodiments, the method may operate in near real-time, enabling dynamic content tracking and automated rights enforcement at scale.

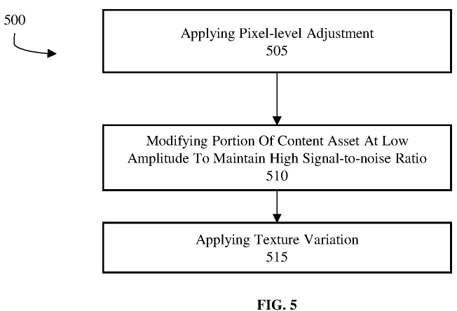

With reference to FIG. 5, a flowchart diagram illustrating the steps for a method 500 for the substantially imperceptible variation of a content asset, wherein the content asset is a visual media, is shown, according to an example embodiment. The method 500 is executed by a system configured to apply visual modifications to a content asset such that the modifications are imperceptible to human observers but carry identifiable data for tracking or verification purposes. The system may include one or more processors, media manipulation modules, and storage components for managing and modifying digital visual content.

In step 505, the system applies a pixel-level adjustment to the content asset. This step includes modifying at least one of pixel brightness, pixel color saturation, pixel contrast, and pixel arrangement. The adjustments are applied in a manner that minimally affects perceptual quality but introduces a unique variation to the visual signal. The system may utilize a deterministic algorithm or random seed to govern the location, intensity, and type of adjustment applied to individual pixels or pixel regions. For instance, slight modulation of luminance values across a spatial grid may encode variation while remaining below a perceptual threshold, thereby avoiding visual artifacts or distortion.

In step 510, the system modifies a portion of the content asset at a low amplitude to maintain a high signal-to-noise ratio. In this step, the modification is applied such that the embedded variation does not overwhelm the original content signal. This is particularly useful in high-resolution images or visually complex scenes where low-amplitude changes can be embedded with minimal perceptual impact. The system may analyze frequency domains or local variance to identify areas suitable for embedding low-amplitude changes, thereby ensuring that the variation is uniformly distributed or strategically located to evade visual detection while maintaining robustness against typical post-processing or compression.

The signal-to-noise ratio (SNR) is a quantitative measure that compares the level of a desired signal to the level of background noise. It is typically expressed in decibels (dB) and is used across various domains—such as audio processing, image analysis, and communication systems—to evaluate the clarity or fidelity of a signal. In the context of digital media modification, particularly where substantially imperceptible variations are introduced, SNR is used to ensure that any embedded information (such as an identifier or watermark) does not degrade the perceptual quality of the media. A high SNR indicates that the original signal dominates and any modifications or noise—including embedded variations—are minimal and unlikely to be detected by a human observer. Conversely, a low SNR would suggest that the embedded variation is too prominent, potentially making the content visibly or audibly distorted. For example, in audio media, the system may embed low-amplitude signals in a way that keeps the SNR above a perceptual threshold, ensuring that the embedded watermark remains below the level of human hearing. In visual content, slight pixel-level changes may be applied such that the ratio of altered pixel values to the original image data is low enough to maintain an SNR that avoids visible artifacts. The system may dynamically assess or optimize SNR during the embedding process by analyzing content characteristics—such as luminance variance in images or frequency masking in audio—to identify regions where higher noise tolerance exists. This allows the system to maximize robustness of the embedded signal while maintaining the perceptual invisibility required for the variation to remain undetectable during ordinary use. Thus, maintaining a favorable signal-to-noise ratio is crucial to ensuring that the imperceptible modifications do not interfere with the user’s experience of the content, while still allowing for effective detection and recovery of the embedded identifiers.

In step 515, the system applies a texture variation to the content asset. This step includes generating at least one of a noise pattern and a background detail and applying it into the content asset. The texture variation may be introduced in the form of fine-grain noise or patterned textures that blend seamlessly with existing background elements. The generated texture may be procedurally synthesized or derived from a reference pattern, and may be applied using alpha blending or masking techniques to maintain seamless integration. The use of textural variation enables encoding of identifiers in areas that are perceptually tolerant to pattern repetition or minor inconsistencies, such as grass, clouds, fabric, or walls in the image. A noise pattern, in the context of imperceptible variation, refers to a subtle, randomized visual or spectral modification applied to a digital media asset—typically in the form of grain, texture, or pixel-level fluctuation—that mimics naturally occurring noise. In visual media, a noise pattern may consist of slight variations in pixel brightness or color values distributed across an image, particularly in background areas or textured regions where the human eye is less sensitive to uniformity. These patterns are designed to blend seamlessly with the underlying content, ensuring they are not perceptible during ordinary viewing while still encoding identifiable information. In audio media, a noise pattern may be applied as a low-level spectral signal that is masked by existing frequencies. In both cases, the pattern serves as a carrier for embedded identifiers—contributing to the traceability of the content—without introducing detectable artifacts or degrading quality.

The method 500 illustrated in FIG. 5 allows the system to introduce a multilayered imperceptible variation to visual media, increasing the resilience of embedded identifiers to tampering, transformation, or lossy processing. Each of the steps may be applied independently or in combination, and may be tailored based on content characteristics, distribution platform, or detection sensitivity requirements.

With reference to FIG. 6, a flowchart diagram illustrating the steps for a method 600 for performing 416 content fingerprinting on the modified content asset is shown, according to an example embodiment. The method 600 may be implemented by a system comprising one or more processors configured to analyze modified media content and generate a robust, unique digital signature based on its perceptual and structural characteristics. The fingerprinting process enables subsequent identification, tracking, and authentication of the modified content asset across digital ecosystems, even in the presence of compression, format changes, or partial modifications.

In step 605, the system analyzes, with the processor, the modified content asset to extract at least one of a spatial feature, a color distribution, an edge pattern, and an object structure. This analysis may be performed on image frames, video sequences, or composite visual data, depending on the nature of the media. Spatial features may include texture gradients, region segmentation, and structural symmetry. Color distribution may include histograms across color spaces (e.g., RGB, HSV, LAB), while edge patterns may be detected using gradient-based algorithms such as Sobel or Canny filters. Object structure extraction may involve object recognition models or bounding box estimations to identify prominent shapes and entities within the content.

In step 610, the system generates, with the processor, a perceptual hash based on the extracted features. The perceptual hash is a condensed representation that encodes the visual signature of the content in a manner that remains stable under common transformations, such as resizing, cropping, or minor distortions. The hashing process may involve quantization of feature values and dimensionality reduction techniques such as principal component analysis (PCA) or locality-sensitive hashing (LSH), yielding a fixed-length fingerprint that reflects the perceptual essence of the content asset.

In step 615, the system applies a frequency-domain transformation, comprising at least one of a Discrete Cosine Transform, a wavelet transform, and a Fourier Transform, to generate a compression-resistant fingerprint. This transformation converts spatial-domain features into the frequency domain, allowing the system to isolate frequency components that are less likely to be altered by lossy compression algorithms. The transformed data is used to construct a secondary fingerprint that complements the perceptual hash, enhancing resilience to degradation and re-encoding.

A frequency-domain transformation is a mathematical process that converts content data from its original spatial domain or time domain representation into the frequency domain, where the signal is expressed in terms of its constituent frequency components rather than pixel or time-based values. For example, in the case of visual media, the spatial domain corresponds to the arrangement of pixel intensity values, while in audio media, the time domain reflects amplitude changes over time.

By transforming the content into the frequency domain, the system is able to isolate and analyze frequency components that are less susceptible to distortion or loss during standard compression operations. Lossy compression algorithms, such as JPEG for images or MP3 for audio, typically target and discard frequency components that are considered perceptually redundant or non-essential to reduce file size. However, certain mid-frequency components tend to be preserved more consistently across encoding formats. The system leverages this behavior by extracting features from those resilient frequency regions to build a secondary fingerprint that remains stable even after the content has been compressed, resized, re-encoded, or partially degraded.

The Discrete Cosine Transform (DCT) is particularly well-suited for image and video processing and is widely used in common compression standards such as JPEG and MPEG. DCT expresses a signal as a sum of cosine functions at varying frequencies and amplitudes, enabling the system to isolate dominant frequency patterns within blocks of the image. Similarly, a wavelet transform provides a multi-resolution analysis of the content by decomposing the signal into components at various scales or resolutions, which is especially useful for capturing localized frequency variations in images or non-stationary signals in audio. The Fourier Transform converts a signal into its constituent sinusoidal frequencies and is particularly useful for analyzing globally distributed periodic structures, such as in audio waveforms.

Once the transformation is complete, the system selects and encodes key coefficients or patterns from the frequency domain representation to form a compression-resistant fingerprint. This fingerprint serves as a robust, compact signature that reflects the inherent structure of the content and complements the perceptual hash, which is derived from features in the spatial or time domain. By combining these two representations, the system significantly enhances the resilience of the overall digital signature, ensuring that it can still be accurately recognized and matched even if the content has undergone format conversion, bandwidth-optimized encoding, or quality degradation due to downstream distribution.

In step 620, the system generates, with the processor, a cryptographic hash based on at least one of the perceptual hash and the compression-resistant fingerprint. The cryptographic hash, such as SHA-256 or another secure hashing algorithm, produces a non-reversible, fixed-length output that serves as a tamper-evident digital signature of the content asset. A cryptographic hash function deterministically maps the input data to a fixed-length output string that is infeasible to reverse-engineer or reproduce without access to the original input. Even the slightest change in the perceptual hash or fingerprint will result in a drastically different cryptographic hash output, providing strong integrity guarantees. This hash is used for secure comparison, storage, and blockchain-based registration, enabling trustless verification of content authenticity.

In some embodiments, the visual media is a motion picture, wherein the substantially imperceptible variation includes a frame timing adjustment. The frame timing adjustment refers to a type of substantially imperceptible variation applied to motion picture media, wherein the timing of one or more video frames is subtly modified without altering the overall visual experience or narrative continuity of the content. This technique is used to embed trackable or identifiable information within the temporal structure of a video in a manner that is not readily perceivable to viewers during ordinary playback. In one embodiment, the system performs frame timing adjustment by modifying the duration of specific frames, either by holding a frame for a slightly longer or shorter time than its original interval, or by inserting or omitting duplicate frames, within thresholds that fall below human perceptual sensitivity. For example, the system may increase the display duration of frame n by 2 milliseconds and decrease the duration of frame n+1 by the same amount, preserving the overall synchronization and playback rate while introducing a unique and controlled variation pattern. These micro-adjustments are typically applied to non-critical scenes or low-motion segments, where slight changes in timing are less likely to be detected. The adjustments may be determined using a deterministic algorithm seeded with content-specific data, ensuring that the timing pattern can be reproduced or verified for authentication purposes. In some embodiments, the timing variation is applied across a sequence of frames to encode binary or numerical data, effectively acting as a temporal watermark embedded within the playback behavior of the video.

Importantly, frame timing adjustment does not affect the visual content of the frames themselves, nor does it introduce perceptible jitter, lag, or desynchronization with associated audio. Playback remains smooth and coherent on standard media players, and the viewer perceives the video as unchanged. However, because the modified timing creates a detectable signature in the temporal metadata or playback trace, it enables robust downstream identification and tracking of the modified video asset, even in cases where the content has been re-encoded, resized, or transcoded. This technique is particularly well-suited for use in high-volume video platforms such as YouTube, TikTok, or streaming services, where traditional watermarking may be stripped or obscured, and where resilience to compression and format changes is essential for persistent media tracking.

In embodiments in which the substantially imperceptible variation includes a frame timing adjustment, steps 625 and 630 may be included in method 600. In step 625, the system analyzes, with the processor, a temporal change between consecutive frames of the modified content asset to identify at least one of an object trajectory and a scene transition. This step is particularly relevant for video-based media, where the fingerprinting process incorporates dynamic characteristics of content over time. The system may utilize optical flow analysis, keyframe detection, or scene boundary identification to capture meaningful motion and structural changes between frames. By evaluating changes between frames, the system extracts motion-based information that enhances the specificity and robustness of the resulting digital fingerprint. Temporal change refers to the difference or variation in visual or structural content that occurs between consecutive frames in a video over time. It captures how elements within the scene—such as objects, lighting, or camera position—move or evolve from one frame to the next, and is essential for identifying motion, transitions, or dynamic behaviors in video media.

Object trajectory refers to the path or motion pattern followed by an identifiable object across successive frames in a video sequence. The system may track such trajectories by detecting consistent movement of features or structures, using methods such as optical flow analysis. Optical flow is a technique that estimates the motion of pixels or regions between consecutive frames based on apparent brightness changes, enabling the system to compute the direction and magnitude of motion vectors. These vectors are used to build a spatiotemporal model of object movement that can uniquely characterize the video. Scene transitions refer to structural changes in the video that mark the end of one continuous shot and the beginning of another. These transitions may be abrupt (hard cuts) or gradual (such as dissolves or fades), and they often correspond to semantic breaks in the video content. The system may employ scene boundary detection techniques to identify such transitions, using a combination of histogram comparison, edge density variation, color distribution shifts, or audio-visual synchronization cues. Additionally, keyframe detection may be performed to isolate representative frames within a scene that capture its defining features.

By analyzing temporal changes in this manner, the system generates a motion fingerprint that encodes temporal consistency, object persistence, and scene structure—attributes that remain relatively stable even if the video is compressed, cropped, or transcoded. These motion-based features are particularly resistant to frame-level editing and are difficult to replicate or forge, making them valuable components of a comprehensive and resilient digital signature. This temporal analysis augments the spatial and frequency-domain components of the fingerprint, allowing the system to account for both what the content is (frame-by-frame) and how it behaves over time. As a result, the overall fingerprint becomes more precise and better suited for verifying the authenticity and origin of video content in environments where such content is frequently modified, repackaged, or redistributed.

In step 630, the system generates a motion fingerprint based on at least one of a motion vector, a frame-to-frame spatial relationship, and a temporal feature persistence, wherein the motion fingerprint is used in generating the unique digital signature. Motion vectors represent directional changes in pixel blocks across frames, while spatial relationships quantify object displacement or continuity. A frame-to-frame spatial relationship refers to the positional and structural correlation of visual elements between consecutive frames in a video. It captures how objects, shapes, or features maintain, shift, or transform their spatial arrangement over time, enabling the system to detect consistent movement, deformation, or stability across the video sequence. This relationship is important to identifying motion continuity and tracking objects or scenes throughout the content. Temporal feature persistence captures how long particular objects or patterns remain visible across multiple frames. The motion fingerprint enriches the overall content signature by embedding dynamic properties that are uniquely tied to the content’s motion behavior, enabling high-confidence identification of video assets even when frames are re-encoded or partially replaced.

The method 600 may be performed in sequence or in parallel, and may be integrated into a larger system for digital media protection, enabling robust and scalable identification of modified content assets in distributed environments.

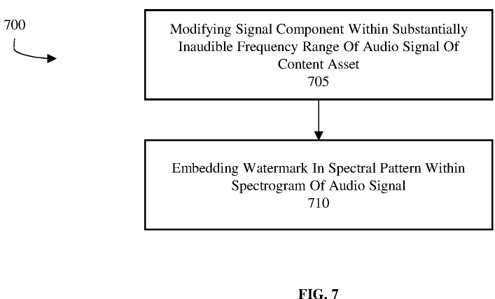

With reference to FIG. 7, a flowchart diagram illustrating the steps for a method 700 for the substantially imperceptible variation of auditory media in a motion picture is shown, according to an example embodiment. The method 700 may be executed by a system comprising at least one processor configured to apply audio-based modifications that are imperceptible to human listeners, yet embed identifiable information suitable for downstream tracking, fingerprinting, or verification.

In step 705, the system modifies a signal component within a substantially inaudible frequency range of an audio signal of the content asset. This step includes identifying a frequency band that falls outside the normal human auditory range, which is typically below 20 Hz or above 20 kHz, and introducing signal alterations within that band. These modifications may involve the injection of amplitude- or phase-modulated signals, frequency-shifted carriers, or pseudo-random sequences that do not interfere with the audible content. The inaudible frequency component may be modulated in accordance with a deterministic pattern to enable reliable detection and decoding. In one embodiment, psychoacoustic masking techniques are employed to ensure that the inserted signal components remain imperceptible even under amplified playback or compression. This step ensures that an identifying signal can be embedded without degrading the listener's experience or altering the perceptual fidelity of the content.

In step 710, the system embeds a watermark in a spectral pattern within a spectrogram of the audio signal. A spectrogram of the audio signal is a visual representation of how the frequency content of the audio changes over time. It displays time on one axis, frequency on the other, and uses color or intensity to indicate the amplitude (or energy) of each frequency at each moment. This time-frequency analysis helps reveal patterns, harmonics, and hidden features within the audio, making it useful for tasks like audio fingerprinting, speech analysis, or watermark embedding. This step involves transforming the time-domain audio signal into the time-frequency domain using a Short-Time Fourier Transform (STFT) or a wavelet transform to generate a spectrogram. The system then selectively modifies spectral bins or coefficients within the spectrogram to encode watermark data. The embedded watermark may comprise a digital payload that includes information such as content ID, timestamp, user ID, or cryptographic hashes. The watermark is designed to be robust to typical signal processing operations such as lossy compression, filtering, and resampling. Additionally, the watermark pattern may be encoded redundantly or adaptively across time and frequency regions of the spectrogram to maintain resilience against signal degradation or partial erasure. The use of spectral domain watermarking enables a high degree of imperceptibility and retrieval accuracy, particularly when combined with error correction encoding and perceptual shaping.

The method 700, as shown in FIG. 7, enables the embedding of audio-based identifiers that are resistant to manipulation and imperceptible to human perception, thereby providing a secure and reliable mechanism for authenticating, tracking, or auditing auditory media content.

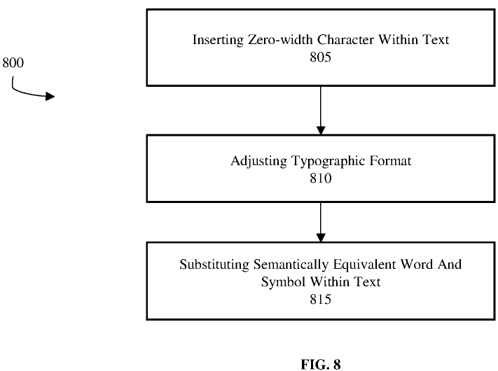

With reference to FIG. 8, a flowchart diagram illustrating the steps for a method 800 for the substantially imperceptible variation of a content asset including a textual component is shown, according to an example embodiment. The method 800 may be performed by a system configured to process digital text and embed traceable or uniquely identifying information within the text in a manner that does not perceptibly alter its meaning, layout, or readability. The embedded variations enable tracking, fingerprinting, or verification of text-based content without introducing detectable anomalies to the end user.

In step 805, the system inserts a zero-width character within the text. This step provides a perceptually insignificant variation that does not substantially alter either the visual rendering or the semantic meaning of the content. Zero-width characters are Unicode characters that occupy no visible space when rendered in standard text environments. These may include characters such as the zero-width space (U+200B), zero-width non-joiner (U+200C), and zero-width joiner (U+200D). The system strategically places one or more of these characters at specific positions within the text, such as between letters, words, or punctuation marks, based on a deterministic or pseudo-randomized algorithm. The insertion does not affect the display or meaning of the text but provides a machine-detectable marker that can be used to uniquely identify or authenticate the content.

In step 810, the system adjusts a typographic format, including at least one of a line height, a kerning, a character spacing, and a word spacing. These modifications pertain to the visual presentation of the text rather than its semantic content. For example, the system may slightly increase or decrease the spacing between specific characters (kerning) or the vertical distance between lines of text (line height) to encode variation. These typographic adjustments are subtle enough to fall within acceptable formatting thresholds, ensuring that the layout appears normal, or visually imperceptible to a typical human reader while embedding an identifiable pattern into the rendering structure of the document. In some embodiments, these variations may be encoded across multiple text blocks or documents to improve resilience against text copying, reformatting, or OCR-based extraction.

In step 815, the system substitutes a semantically equivalent word and symbol within the text. This involves identifying a word, phrase, or character in the original text and replacing it with an alternate version that conveys the same meaning or function. For instance, the system may substitute "e-mail" with "email," or replace a symbol such as "&" with "and." These substitutions are contextually aware and preserve the syntactic and semantic integrity of the document. By applying variation at the linguistic level, the system introduces an additional dimension of imperceptible modification that remains embedded in the content even if it is reformatted or partially altered.

The method 800 shown in FIG. 8 allows the system to embed uniquely identifying information into textual content in a layered and resilient manner. The combination of zero-width character insertion, typographic adjustment, and semantic substitution enhances the ability to trace, detect, and verify unauthorized duplication or modification of the text, while maintaining the content’s original appearance and intelligibility.

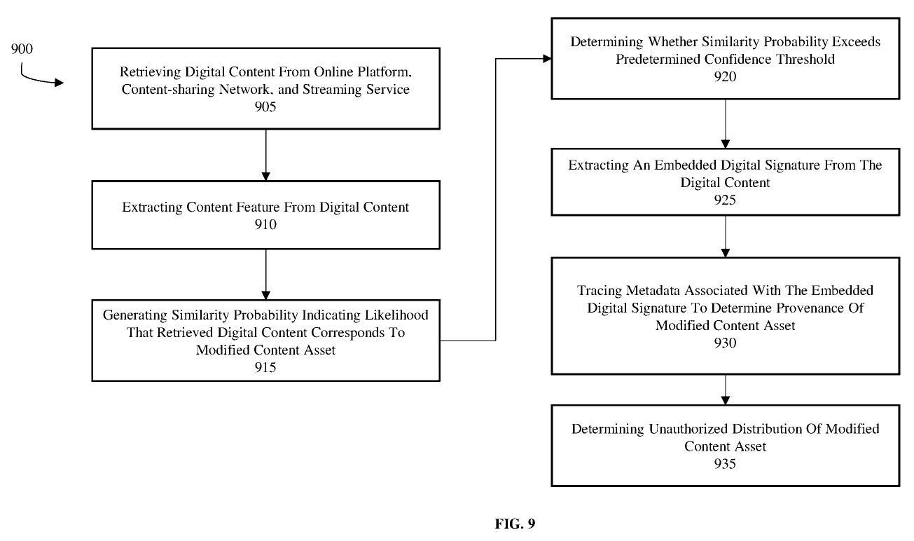

With reference to FIG. 9, a flowchart diagram illustrating the steps for a method 900 for scanning digital content on a connected database for unauthorized copies of the modified content asset is shown, according to an example embodiment. The method 900 may be executed by a system comprising one or more processors configured to monitor third-party digital platforms and repositories to detect, analyze, and verify the presence of potentially unauthorized copies of previously modified content assets. The scanning process relies on content feature analysis, similarity assessment, and digital signature extraction to trace content origin and identify unauthorized distribution.

In step 905, the system retrieves a digital content from at least one of an online platform, a content-sharing network, and a streaming service. The retrieval process may be conducted through automated crawling, application programming interfaces (APIs), or direct access to databases provided under license or partnership agreements. The digital content may include image files, video recordings, audio tracks, or hybrid media compositions. The system may retrieve metadata associated with each piece of content, such as timestamps, user identifiers, content tags, and file formats, to support subsequent analysis.

In step 910, the system extracts a content feature from the digital content, wherein the content feature comprises at least one of a spatial feature, a motion vector, a color distribution, and an object structure. Spatial features may include texture patterns, geometric alignments, and local descriptors, such as scale-invariant feature transform (SIFT) or histogram of oriented gradients (HOG). Motion vectors may be extracted from consecutive video frames to represent object movement or camera motion. Color distribution analysis may involve computing histograms or dominant color sets within specified regions. Object structure extraction may utilize machine learning models trained for object detection and segmentation to isolate semantic elements within the content. The extracted features are used to build a content profile suitable for similarity comparison.

In step 915, the system generates a similarity probability indicating a likelihood that the retrieved digital content corresponds to the modified content asset. This step includes comparing the extracted content features against a reference fingerprint or signature associated with the modified content asset. The similarity probability may be computed using statistical distance metrics, such as cosine similarity, Hamming distance, or probabilistic models incorporating feature weightings. The system may use thresholding and normalization techniques to ensure the similarity score is robust against common content transformations such as compression, resolution scaling, cropping, or encoding changes.

In step 920, the system determines whether the similarity probability exceeds a predetermined confidence threshold. This threshold may be configured based on empirical evaluation, acceptable false positive rates, or adaptive calibration based on the platform type and content characteristics. If the similarity probability does not exceed the threshold, the content may be disregarded or flagged for further review. If the threshold is exceeded, the system proceeds to additional verification procedures to confirm identity and origin.

In step 925, in response to determining that the similarity probability exceeds the confidence threshold, the system extracts an embedded digital signature from the digital content. Extracting an embedded digital signature from the digital content refers to the process by which a system identifies and retrieves a previously embedded, machine-readable identifier that has been imperceptibly incorporated into a content asset. The embedded digital signature is designed to persist within the content even after it has been distributed, transformed, or re-encoded, and serves as a unique, verifiable marker for content tracking, provenance verification, and rights enforcement. The embedded digital signature may be located through watermarking patterns, spectral tags, or imperceptibly varied features that were introduced into the original modified content asset.

In one embodiment, the system receives or scans a candidate digital content item, such as an image, video, audio file, or text document, and initiates a decoding process to detect the presence of embedded signature data. For visual media, the system analyzes pixel-level variations, spatial patterns, or frequency-domain coefficients to identify structured anomalies that correspond to the imperceptibly embedded signature. These anomalies may be extracted using inverse transforms (e.g., inverse DCT or inverse wavelet transformation) and decoding algorithms configured to recognize pre-defined modulation schemes or pattern encodings.

For audio-based media, the system performs time-frequency analysis, such as through Short-Time Fourier Transform (STFT), to evaluate spectral regions where watermark signals or amplitude-modulated tones may have been embedded. In cases where the variation was introduced in an inaudible frequency band or masked region, the system applies bandpass filtering and pattern recognition techniques to isolate and extract the encoded data.

In textual content, the extraction process may involve scanning for the presence of zero-width Unicode characters or subtle typographic modifications, such as deviations in font, kerning, or spacing, that encode a digital signature. The system reconstructs the signature by parsing these elements based on a known embedding scheme or through comparison with a baseline version.

Once the raw embedded data is extracted, the system decodes and reconstructs the digital signature, typically consisting of a unique hash, identifier, or token. This reconstructed signature can then be matched against a registry or blockchain ledger containing a database of valid signatures, allowing the system to verify the authenticity and origin of the content asset. The signature may also contain embedded metadata, such as content IDs, timestamp information, or user identifiers, which further enable traceability and enforcement.

In step 930, the system traces metadata associated with the embedded digital signature to determine a provenance of the modified content asset. This may involve querying a blockchain ledger or a secure database to identify the registered source, timestamp, and authorized distribution chain of the asset. Provenance analysis may also identify the originator, licensee, or distribution context for the content in question. Tracing metadata associated with the embedded digital signature to determine a provenance of the modified content asset refers to the process by which a system, after extracting an embedded digital signature from a content item, retrieves and analyzes associated metadata to reconstruct the origin, ownership history, and distribution pathway of that asset. This process enables verification of the content's authenticity and identification of unauthorized redistribution or tampering.

Once the embedded digital signature has been successfully extracted from a content asset, such as an image, audio file, video clip, or text document, the system uses the signature as a lookup key to query a secure registry, such as a blockchain ledger, a centralized rights management database, or a distributed content verification network. The signature may correspond to a cryptographic hash or a unique content identifier that was generated at the time the content was initially modified and embedded with imperceptible variations. Upon querying the ledger, the system retrieves metadata records associated with the signature. This metadata may include, for example, the original content asset ID, the creator or rights holder's identifier, the timestamp of creation or modification, the location or IP address from which the content was registered, and the distribution policy or licensing terms under which the asset was published. In some embodiments, the metadata may also include a chain of custody log or a record of authorized platforms through which the content has been lawfully distributed. By analyzing this metadata, the system can determine the provenance of the content, i.e., the verified history of the content's creation, ownership, and distribution. This analysis helps distinguish between authorized and unauthorized copies. For instance, if the extracted digital signature matches a record that indicates the content was originally created by a specific user or entity and licensed only to specific domains or services, the appearance of that content on an unrelated or unlicensed platform may indicate an unauthorized redistribution.

In some implementations, the provenance determination may also involve cross-referencing user credentials, digital certificates, or transactional records embedded within the blockchain to establish the legitimacy of the party that distributed or altered the content. This provenance data may then be used to support downstream actions, such as automated takedown requests, issuance of legal notices, or initiation of smart contract-based enforcement mechanisms. Tracing metadata associated with an embedded digital signature allows the system to go beyond simple fingerprint matching by providing contextual, auditable information about where the content came from, who created it, how it was modified, and whether its current presence or use is authorized, enabling a strong, transparent, and tamper-resistant approach to content verification and rights enforcement.

In step 935, the system determines an unauthorized distribution of the modified content asset. This determination may be made based on the absence of a distribution license, a mismatch between the platform hosting the content and the authorized channels of distribution, or other violation criteria defined by policy or digital rights management parameters. Upon confirming an unauthorized instance, the system may log the event, alert stakeholders, or initiate a subsequent enforcement or remediation process. The method 900 enables automated, high-confidence identification of unauthorized media content, supporting enforcement and compliance efforts across distributed and dynamic digital environments.

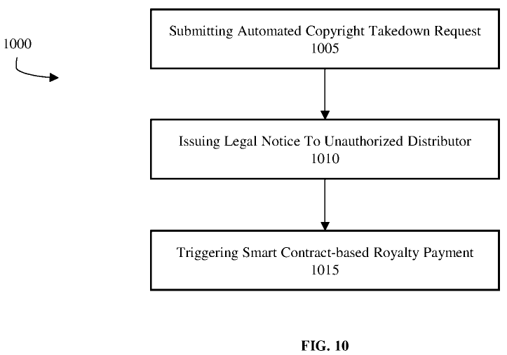

With reference to FIG. 10, a flowchart diagram illustrating the steps for a method 1000 for initiating 430 an enforcement action with a third party is shown, according to an example embodiment. The method 1000 may be executed by a system configured to respond to a detected unauthorized distribution of a modified content asset by initiating one or more remedial or compensatory actions through automated or semi-automated processes. These enforcement actions may be initiated over a communications network and may be directed to content-hosting platforms, distribution networks, or legal entities.

In step 1005, the system submits an automated copyright takedown request. This step includes generating and transmitting a takedown notice in accordance with applicable digital rights legislation, such as the Digital Millennium Copyright Act (DMCA) or similar frameworks in other jurisdictions. The system may pre-populate the takedown request with metadata derived from the detected unauthorized content, including URLs, timestamps, platform identifiers, and the embedded digital signature associated with the original modified content asset. The takedown request may be transmitted to the content-hosting provider via an application programming interface (API), email gateway, or dedicated reporting portal. In some embodiments, the system may also include legal disclaimers, attestation of ownership, and authorization for the removal action.

In step 1010, the system issues a legal notice to an unauthorized distributor. This step may be executed in parallel with or subsequent to the takedown submission and involves the preparation and delivery of a legal communication, such as a cease-and-desist letter, to the party responsible for the unauthorized distribution. The notice may identify the protected work, describe the nature of the infringement, cite applicable legal provisions, and request immediate cessation of the infringing activity. The system may retrieve the distributor’s contact information from publicly available records, digital platform metadata, or blockchain-anchored identifiers. In certain implementations, the legal notice may also include a warning of further legal consequences or a settlement offer, depending on policy configurations and the scope of infringement.

In step 1015, the system triggers a smart contract-based royalty payment. This step includes activating a preconfigured smart contract stored on a blockchain network, which facilitates the automatic distribution of royalty payments to designated rights holders upon detection of usage or infringement events. The smart contract may be linked to the digital signature of the modified content asset and may be programmed to execute payment conditions when unauthorized usage is verified. This ensures a tamper-resistant and automated monetary remedy that operates without the need for centralized enforcement intermediaries. In one embodiment, the smart contract may deduct payment from a platform escrow, streaming service partner, or bonded distributor, and allocate funds to rights holders in accordance with predefined royalty splits.

The method 1000 enables efficient and scalable enforcement of digital media rights, providing automated mechanisms for both punitive and compensatory actions in response to unauthorized content distribution. These actions may be taken individually or in sequence and may be integrated with broader media monitoring and rights management systems.

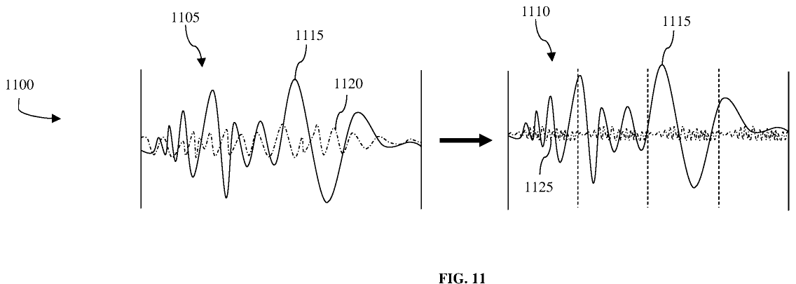

With reference to FIG. 11, the process 1100 of the substantially imperceptible variation of auditory media 1105 is shown, according to an example embodiment. FIG. 11 illustrates a transformation applied to an audio signal for the purpose of embedding imperceptible identifiers within the signal structure, enabling subsequent identification or verification without degrading the perceptual quality of the media. Initially, auditory media 1105 comprises an original audio waveform 1115 and a background signal 1120. The original waveform 1115 represents the primary audible content of the audio signal, while the background signal 1120 may include ambient noise or low-level spectral information that does not significantly affect perceptual clarity. The system analyzes this auditory signal in both the time and frequency domains to identify regions suitable for modification based on psychoacoustic masking thresholds, signal sparsity, or spectral flatness.

The process proceeds to a modified version of the auditory media 1110, where an imperceptible variation has been introduced. In this modified auditory media 1110, the original waveform 1115 is preserved while a secondary signal 1125 is embedded into a substantially inaudible frequency band or masked temporal segment of the signal. This embedded signal 1125 may encode identifying information in the form of low-amplitude modulations, spread-spectrum sequences, or encoded watermark payloads. The embedded signal 1125 is strategically distributed across the waveform such that it remains below the threshold of human hearing, leveraging psychoacoustic properties and temporal masking effects. The dotted vertical lines in the modified auditory media 1110 represent targeted insertion points or modified intervals, which may correspond to frequency bands, time slices, or phase-aligned moments within the original waveform. These modifications are performed in a deterministic manner to ensure that they are recoverable during a subsequent detection or fingerprinting operation.

The process 1100 allows the system to embed metadata or identifiers into an audio signal without introducing perceivable distortions. The imperceptible variations may survive typical transformations such as compression, format conversion, or streaming, and enable traceability of the audio content across digital ecosystems.

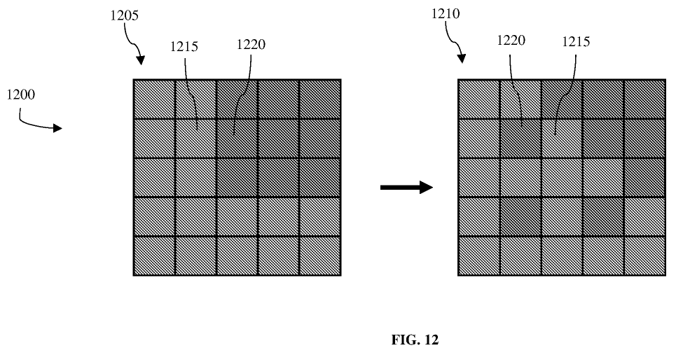

With reference to FIG. 12, the process 1200 of the substantially imperceptible variation of visual media 1205 is shown, according to an example embodiment. FIG. 12 illustrates a modification operation applied to a visual content asset at the pixel level, whereby imperceptible changes are introduced into a pixel matrix to embed trackable or identifiable information without altering the perceptual quality of the image. The visual media 1205 on the left side of the figure represents an original pixel matrix comprising multiple pixels arranged in rows and columns. Each individual cell in the matrix corresponds to a discrete pixel, and each pixel carries a respective intensity or color value. As depicted, pixel 1215 and pixel 1220 are adjacent pixels having subtly different grayscale or color intensity values. These values are representative of naturally occurring gradients in the image and do not indicate any intentional variation.

The modified visual media 1210, shown on the right side of the figure, reflects the application of an imperceptible variation performed by the system. In this example embodiment, the system has executed a pixel-level adjustment by interchanging the positions of pixel 1215 and pixel 1220. The swap results in a localized change in pixel arrangement that introduces a low-level structural variance into the image without perceptibly altering the overall appearance to a human observer. The adjustment is subtle enough to fall within visual tolerance thresholds and leverages the human visual system’s insensitivity to minor spatial perturbations in non-salient image regions. The imperceptible variation illustrated in FIG. 12 may be governed by a deterministic algorithm that identifies candidate pixels for manipulation based on luminance gradients, edge proximity, or texture uniformity. In some embodiments, such variations may encode a digital payload by means of controlled permutations or modulations distributed across the image in accordance with an embedding key. These variations are designed to be resilient to common image transformations such as scaling, compression, and reformatting.

The process 1200 enables the system to embed uniquely identifiable information within an image frame or still visual asset without compromising image quality or introducing visible artifacts, thereby supporting robust content identification, tracking, and anti-piracy enforcement in digital media workflows.

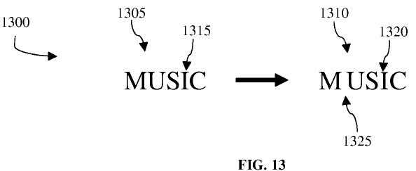

With reference to FIG. 13, the process of the substantially imperceptible variation of the textual component 1305 is shown, according to an example embodiment. The figure depicts a comparison between an original textual representation and a modified version, wherein imperceptible modifications have been introduced into the text to embed identifying information while preserving its semantic integrity and overall perceptual appearance. The textual component 1305 includes the word “MUSIC,” wherein character 1315 represents the letter “I” rendered in a default font and font size consistent with the rest of the word. This original version maintains uniform typographic characteristics throughout and appears visually standard to a human reader.

In the modified textual component 1310, the system has applied two forms of substantially imperceptible variation. First, character 1320 corresponds to the letter “I” in the modified version of “MUSIC,” which has been replaced with a typographically similar character rendered in a different font and/or font size. This alternate rendering is carefully selected to visually match the original character 1315 as closely as possible, such that the change is imperceptible under standard viewing conditions. Despite appearing identical, the underlying glyph data, such as font family, style metadata, or character encoding, differs from the original, thereby introducing a machine-detectable variation that enables identification or tracking.

The system inserts a zero-width character 1325 adjacent to or within the modified word “MUSIC.” This zero-width character may be a Unicode character such as a zero-width space (U+200B), zero-width non-joiner (U+200C), or zero-width joiner (U+200D), which occupies no visible space when rendered but can be detected programmatically. The insertion of character 1325 does not affect layout, alignment, or semantic interpretation, but serves as an embedded marker for downstream analysis or verification.

Together, these modifications exemplify how the system introduces layered, substantially imperceptible variations into textual content by altering both typographic form and invisible character structure. The process 1300 ensures that the modified textual component 1310 remains visually indistinguishable from the original 1305 while embedding covert data for purposes such as content provenance verification, digital rights enforcement, or forensic tracking. The combined use of font-based substitutions and zero-width characters increases the robustness and stealth of the embedded identifiers while minimizing the risk of perceptual detection or disruption.

The embodiments illustrated in FIG. 11 through 13 are exaggerated examples provided for the purpose of visual clarity and conceptual understanding. In actual implementation, the variations introduced to the media, whether auditory or visual, are engineered to be substantially imperceptible to human perception and would not be readily distinguishable through casual observation or listening.

In FIG. 11, the modified auditory media 1110 is shown with a visibly distinct embedded signal 1125 layered onto the original waveform 1115. This depiction exaggerates the amplitude and visibility of the embedded signal to demonstrate the presence and placement of the imperceptible variation. In practice, the embedded signal would typically have a much lower amplitude, often below the auditory threshold, and would be masked within frequency ranges or temporal segments where human hearing is least sensitive. Psychoacoustic models would be used to ensure that the signal remains inaudible under normal playback conditions, including compressed or streamed audio formats.

Similarly, in FIG. 12, the visual media modification process is represented with an exaggerated change in pixel position between the original visual media 1205 and the modified version 1210. The swapped pixels 1215 and 1220 are shown in a simplified grayscale matrix to highlight the structural alteration. However, in real-world implementations, pixel-level modifications are far more subtle. These changes may involve minimal adjustments, which are typically within ranges that remain undetectable to the human eye, to pixel brightness, color saturation, or spatial arrangement. Additionally, the modified pixels would be selected from areas of the image where perceptual sensitivity is lowest, such as in backgrounds, low-contrast regions, or highly textured areas.

The embodiment illustrated in FIG. 13 is an exaggerated example provided for the purpose of visual clarity and conceptual demonstration. In practical implementation, the variations introduced into the textual component, such as font substitution and the insertion of zero-width characters, are configured to be substantially imperceptible to human observers under normal reading conditions. Specifically, the difference between character 1315 and character 1320 is shown in an exaggerated manner to visually highlight the replacement of the original font and font size with an alternate, nearly identical rendering. In real-world use, the selected font and size variations are chosen to match the original typographic properties with such high fidelity that a human reader would not notice any distinction. The rendering engine or display system would display both characters in a manner that is visually consistent, ensuring that the substitution has no perceptual impact on the layout, emphasis, or readability of the text. Similarly, the presence of the zero-width character 1325 is made explicit in FIG. 13 to demonstrate its inclusion in the modified textual component. However, in actual deployment, this character occupies no visible space and introduces no spacing or alignment shift. Its insertion does not alter the appearance of the text in any way and remains invisible to both end users and typical document rendering software.

In FIGS. 11 through 13, the visualizations are intended to clearly convey the mechanisms of imperceptible modification. However, the actual values, magnitudes, and locations of these variations are optimized using perceptual models, signal processing algorithms, and content-specific heuristics to ensure that the embedded data does not introduce any noticeable degradation or alteration to the end-user experience.

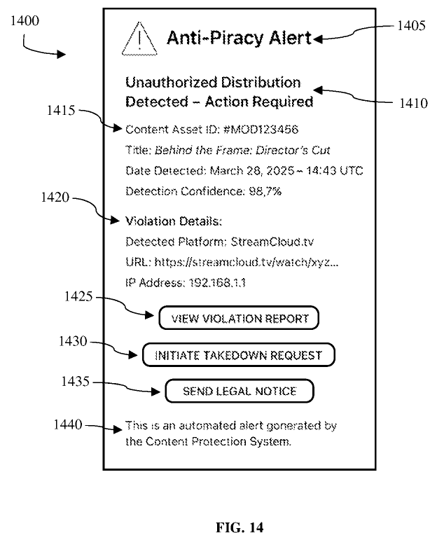

With reference to FIG. 14, a graphical user interface 1400 for an anti-piracy alert is shown, according to an example embodiment. The user interface 1400 is configured to notify an authorized user, such as a rights holder, content administrator, or enforcement agent, of a detected unauthorized distribution of a protected content asset. The alert is generated and displayed by a content protection system in response to a successful detection and validation of infringement based on embedded identifiers and content fingerprinting.

At the top of the interface, an alert banner 1405 displays a prominent warning symbol and the label “Anti-Piracy Alert” to visually indicate the critical nature of the message. Positioned directly below, the alert message section 1410 includes a status notification reading “Unauthorized Distribution Detected – Action Required,” which communicates the urgency of the response needed.

The alert includes a content summary section 1415, which identifies the specific digital asset associated with the violation. In the illustrated embodiment, the content is identified by a content asset ID (“#MOD123456”) and includes a title field (“Behind the Frame: Director’s Cut”), a date and time of detection (“March 28, 2025 – 14:43 UTC”), and a detection confidence value (“98.7%”), which quantifies the statistical likelihood that the identified media corresponds to the modified content asset registered in the system.

A violation details section 1420 provides additional metadata pertaining to the incident. This includes identification of the platform on which the unauthorized distribution was detected (in this example, “StreamCloud.tv”), a uniform resource locator (URL) linking to the infringing content, and an internet protocol (IP) address (“192.168.1.1”) associated with the distribution event. These details are compiled by the system based on automated web crawling, feature matching, and signature extraction processes.

Below the violation details are a set of user-interactive controls, which allow the recipient of the alert to initiate responsive enforcement actions. These include a “VIEW VIOLATION REPORT” button 1425, which links to a detailed forensic report containing media comparisons and metadata; an “INITIATE TAKEDOWN REQUEST” button 1430, which sends a formal takedown submission to the identified platform; and a “SEND LEGAL NOTICE” button 1435, which triggers the transmission of a pre-formulated legal communication to the suspected unauthorized distributor.

The interface also includes a footer message 1440 indicating that the alert is automatically generated by the content protection system, thereby confirming the automated and real-time nature of the detection and notification workflow. The graphical user interface 1400 facilitates rapid response to detected infringement events, providing actionable intelligence and embedded controls within a unified display environment. This enables efficient mitigation of unauthorized distribution while minimizing manual review or legal overhead.

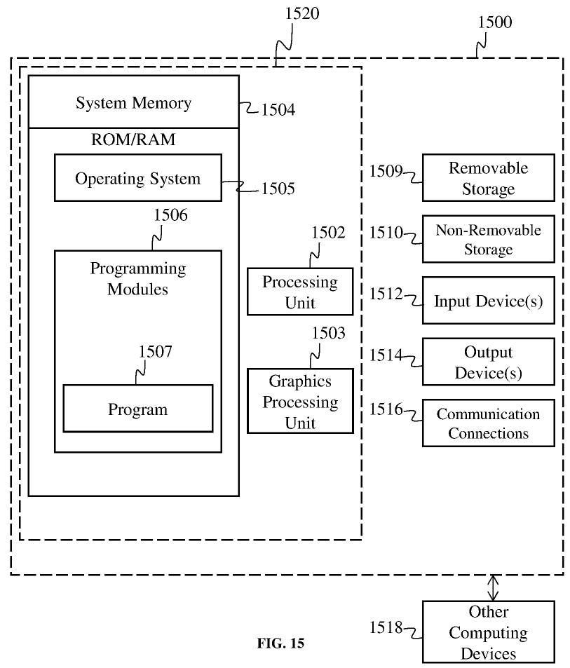

FIG. 15 is a block diagram of a system including an example computing device 1500 and other computing devices. Consistent with the embodiments described herein, the aforementioned actions performed by server 102 or devices 116, 120, 124, and 126 may be implemented in a computing device, such as the computing device 1500 of FIG. 15. Any suitable combination of hardware, software, or firmware may be used to implement the computing device 1500. The aforementioned system, device, and processors are examples and other systems, devices, and processors may comprise the aforementioned computing device. Furthermore, computing device 1500 may comprise an operating environment for the methods shown in FIGS. 10 through 14 above.

With reference to FIG. 15, a system consistent with an embodiment of the invention may include a plurality of computing devices, such as computing device 1500. In a basic configuration, computing device 1500 may include at least one processing unit 1502 and a system memory 1504. Depending on the configuration and type of computing device, system memory 1504 may comprise, but is not limited to, volatile (e.g., random access memory (RAM)), nonvolatile (e.g., read-only memory (ROM)), flash memory, or any combination or memory. System memory 1504 may include operating system 1505, one or more programming modules 1506 (such as program module 1507). Operating system 1505, for example, may be suitable for controlling computing device 1500's operation. In one embodiment, programming modules 1506 may include, for example, a program module 1507. Furthermore, embodiments of the invention may be practiced in conjunction with a graphics library, other operating systems, or any other application program and is not limited to any particular application or system. This basic configuration is illustrated in FIG. 1500 by those components within a dashed line 1520.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and nonvolatile, removable, and non-removable media implemented in any method or technology for storage of information, such as computer readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 1500. Any such computer storage media may be part of device 1500. Computing device 1500 may also have input device(s) 1512 such as a keyboard, a mouse, a pen, a sound input device, a camera, a touch input device, etc. Output device(s) 1514 such as a display, speakers, a printer, etc. may also be included. The aforementioned devices are only examples, and other devices may be added or substituted.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term "modulated data signal" may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 1504, including operating system 1505. While executing on processing unit 1502, programming modules 1506 may perform processes including, for example, one or more of the methods shown in FIGS. 10 through 14 above. Computing device 1500 may also include a graphics processing unit 1503, which supplements the processing capabilities of processor 1502 and which may execute programming modules 1506, including all or a portion of those processes and methods shown in FIGS. 10 through 14 above. The aforementioned processes are examples, and processing units 1502, 1503 may perform other processes. Other programming modules that may be used in accordance with embodiments of the present invention may include electronic mail and contacts applications, word processing applications, spreadsheet applications, database applications, slide presentation applications, drawing or computer aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including handheld devices, multiprocessor systems, microprocessor based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general-purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality and acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for modifying and tracking digital media using imperceptible identifiers, the method comprising:
receiving, over a communications network, a content asset from a content source;
modifying, with at least one processor, the content asset by applying a substantially imperceptible variation to the content asset to generate a modified content asset;
generating, with a processor, a unique digital signature for the modified content asset; and
storing, with the processor, the unique digital signature in a blockchain ledger.

2. The method of claim 1, wherein the content asset comprises a visual media, wherein the substantially imperceptible variation comprises at least one of:
applying a pixel-level adjustment, wherein at least one of pixel brightness, pixel color saturation, pixel contrast, and pixel arrangement is modified and applied to the content asset;
modifying a portion of the content asset at a low amplitude to maintain a high signal-to-noise ratio; and
applying a texture variation, comprising generating at least one of a noise pattern and a background detail and applying it into the content asset.

3. The method of claim 2, wherein the substantially imperceptible variation is applied based on a deterministic algorithm that generates a plurality of values, the plurality of values being used to determine at least one of a location, a type, an intensity of the substantially imperceptible variation within the content asset.

4. The method of claim 3, wherein generating the unique digital signature comprises performing content fingerprinting on the modified content asset, the content fingerprinting comprising:
analyzing, with the processor, the modified content asset to extract at least one of a spatial feature, a color distribution, an edge pattern, and an object structure;
generating, with the processor, a perceptual hash based on the extracted features;
applying a frequency-domain transformation, comprising at least one of a Discrete Cosine Transform, a wavelet transform, and a Fourier Transform, to generate a compression-resistant fingerprint; and
generating, with the processor, a cryptographic hash based on at least one of the perceptual hash and the compression-resistant fingerprint.

5. The method of claim 4, wherein the visual media is a motion picture, wherein the substantially imperceptible variation comprises a frame timing adjustment.

6. The method of claim 5, wherein the content fingerprinting further comprises:
analyzing, with the processor, a temporal change between consecutive frames of the modified content asset to identify at least one of an object trajectory and a scene transition; and
generating a motion fingerprint based on at least one of a motion vector, a frame-to-frame spatial relationship, and a temporal feature persistence, wherein the motion fingerprint is used in generating the unique digital signature.

7. The method of claim 6, wherein the motion picture comprises an auditory media, wherein the substantially imperceptible variation comprises at least one of:
modifying a signal component within a substantially inaudible frequency range of an audio signal of the content asset; and
embedding a watermark in a spectral pattern within a spectrogram of the audio signal.

8. The method of claim 7, wherein the content asset comprises a textual component, and wherein the substantially imperceptible variation comprises at least one of:
inserting a zero-width character within the textual component;
adjusting a typographic format, including at least one of a line height, a kerning, a character spacing, and a word spacing; and
substituting a semantically equivalent word and symbol within the textual component.

9. The method of claim 8, further comprising scanning digital content on a connected database, with the processor, for unauthorized copies of the modified content asset, the scanning comprising:
retrieving a digital content from at least one of an online platform, a content-sharing network, and a streaming service;
extracting a content feature from the digital content, wherein the content feature comprise at least one a spatial feature, a motion vector, a color distribution, and an object structure;
generating a similarity probability indicating a likelihood that the retrieved digital content corresponds to the modified content asset;
determining whether the similarity probability exceeds a predetermined confidence threshold; and
in response to determining that the similarity probability exceeds the predetermined confidence threshold:
extracting an embedded digital signature from the digital content; and
tracing metadata associated with the embedded digital signature to determine a provenance of the modified content asset; and
determining an unauthorized distribution of the modified content asset.

10. The method of claim 9, further comprising initiating an enforcement action with a third party, with the processor, over the communications network, upon determining the unauthorized distribution of the modified content asset, wherein the enforcement action comprises at least one of:
submitting an automated copyright takedown request;
issuing a legal notice to an unauthorized distributor; and
triggering a smart contract-based royalty payment.

11. The method of claim 10, further comprising generating an anti-piracy alert and sending a message to a remote computing device, with the processor, in response to detecting the unauthorized distribution of the modified content asset.

12. A method for modifying and tracking audio-based media using imperceptible identifiers, the method comprising:
receiving, over a communications network, a content asset from a content source;
modifying, with at least one processor, the content asset by applying a substantially imperceptible variation to the content asset to generate a modified content asset; wherein the substantially imperceptible variation comprises at least one of:
modifying a signal component within a substantially inaudible frequency range of an audio signal of the content asset; and
embedding a watermark in a spectral pattern within a spectrogram of the audio signal;
generating, with a processor, a unique digital signature for the modified content asset; and
storing, with the processor, the unique digital signature in a blockchain ledger.

13. The method of claim 12, wherein the substantially imperceptible variation is applied based on a deterministic algorithm that generates a plurality of values, the plurality of values being used to determine a location, a type, and an intensity of the substantially imperceptible variation within the content asset.

14. The method of claim 12, wherein generating the unique digital signature comprises performing content fingerprinting on the modified content asset, the content fingerprinting comprising:
analyzing, with the processor, the modified content asset to extract an audio feature;
generating, with the processor, a perceptual hash based on the extracted feature;
applying a frequency-domain transformation, comprising at least one of a Discrete Cosine Transform, a wavelet transform, and a Fourier Transform, to generate a compression-resistant fingerprint; and
generating, with the processor, a cryptographic hash based on at least one of the perceptual hash and the compression-resistant fingerprint.

15. The method of claim 12, further comprising scanning digital content on a connected database, with the processor, for unauthorized copies of the modified content asset, the scanning comprising:
retrieving a digital content from at least one of an online platform, a content-sharing network, and a streaming service;
extracting an auditory content feature from the digital content;
generating a similarity probability indicating a likelihood that the retrieved digital content corresponds to the modified content asset;
determining whether the similarity probability exceeds a predetermined confidence threshold; and
in response to determining that the similarity probability exceeds the predetermined confidence threshold:
extracting an embedded digital signature from the digital content; and
tracing metadata associated with the embedded digital signature to determine a provenance of the modified content asset; and
determining an unauthorized distribution of the modified content asset.

16. The method of claim 12, further comprising initiating an enforcement action with a third party, with the processor, over the communications network, upon determining an unauthorized distribution of the modified content asset, wherein the enforcement action comprises at least one of:
submitting an automated copyright takedown request;
issuing a legal notice to an unauthorized distributor; and
triggering a smart contract-based royalty payment.

17. The method of claim 12, further comprising generating an anti-piracy alert and sending a message to a remote computing device, with the processor, in response to detecting an unauthorized distribution of the modified content asset.

18. A method for modifying and tracking digital media using imperceptible identifiers, the method comprising:
receiving, over a communications network, a content asset from a content source;
modifying, with at least one processor, the content asset by applying a substantially imperceptible variation to the content asset to generate a modified content asset; wherein the substantially imperceptible variation is applied based on a deterministic algorithm that generates a plurality of values, the plurality of values being used to determine at least two of a location, a type, and an intensity of the substantially imperceptible variation within the content asset;
generating, with a processor, a unique digital signature for the modified content asset; and
storing, with the processor, the unique digital signature in a blockchain ledger.

19. The method of claim 18, wherein the substantially imperceptible variation comprises at least one of:
applying a pixel-level adjustment, wherein at least one of pixel brightness, pixel color saturation, pixel contrast, and pixel arrangement is modified and applied to the content asset;
modifying a portion of the content asset at a low amplitude to maintain a high signal-to-noise ratio; and
applying a texture variation, comprising generating at least one of a noise pattern and a background detail and applying it into the content asset.

20. The method of claim 19, wherein generating the unique digital signature comprises performing content fingerprinting on the modified content asset, the content fingerprinting comprising:
analyzing, with the processor, the modified content asset to extract at least one of a spatial feature, a color distribution, an edge pattern, and an object structure;
generating, with the processor, a perceptual hash based on the extracted features;
applying a frequency-domain transformation, comprising at least one of a Discrete Cosine Transform, a wavelet transform, and a Fourier Transform, to generate a compression-resistant fingerprint; and
generating, with the processor, a cryptographic hash based on at least one of the perceptual hash and the compression-resistant fingerprint.
